(19) United States
(12) Patent Application Publication
(10) Pub. No.: US 2025/0156312 A1
(43) Pub. Date: May 15, 2025

(54) STORAGE SYSTEM AND OPERATION METHOD THEREOF

(71) Applicant: SAMSUNG ELECTRONICS CO.,LTD., Suwon-si (KR)

(72) Inventors: Jaehong MIN, Suwon-si (KR); Arvind KRISHNAMURTHY, Seattle, WA (US); Chenxingyu ZHAO, Seattle, WA (US)

(73) Assignees: SAMSUNG ELECTRONICS CO.,LTD., Suwon-si (KR); University of Washington, Seattle, WA (US)

(21) Appl. No.: 18/937,220

(22) Filed: Nov. 5, 2024

Related U.S. Application Data
(60) Provisional application No. 63/548,073, filed on Nov. 10, 2023.

(51) Int. Cl. G06F 12/02

(52) U.S. Cl. CPC G06F 12/023

(57) ABSTRACT

Provided is a method of operating a storage system including a host device, which includes a zone manager, and a storage device. The method includes allocating, by the zone manager, a first essential write resource, a second essential write resource, a first spare write resource, and a second spare write resource to a first logical zone, allocating, by the zone manager, a third essential write resource, a fourth essential write resource, a third spare write resource, and a fourth spare write resource to a second logical zone, and reallocating, by the zone manager, the first spare write resource and the second spare write resource to the second logical zone.

### CROSS-REFERENCE TO RELATED APPLICATION

This application is based on and claims the benefit of U.S. Provisional Patent Application No. 63/548,073, filed on Nov. 10, 2023, in the United States Patent and Trademark Office, the disclosure of which is herein incorporated by reference in its entirety.

### BACKGROUND

One or more example embodiments of the disclosure relate to a computing system, and more particularly, to a storage system and a method of operating the storage system.

A semiconductor memory is classified into a volatile memory device, such as a static random access memory (SRAM) and a dynamic random access memory (DRAM), in which the stored data is lost when power supply is cut off, and a non-volatile memory device, such as a flash memory device, a phase-change random access memory (PRAM), a magnetic random access memory (MRAM), a resistive random access memory (RRAM), and a ferroelectric random access memory (FRAM), in which the stored data is maintained even when the power supply is cut off.

A host device may divide a storage space of a storage device into a plurality of zones and access the plurality of zones. The storage device may only support sequential writing on each of the plurality of zones. The storage device may prohibit random writing in each of the plurality of zones. Storage devices may be provided based on various standards, such as zoned namespace (ZNS) and zoned block device (ZBD). Garbage collection inside the storage device may be eliminated. However, the performance of the storage device supporting writing on a plurality of zones is degraded, and the performance inequality occurs between multiple tenants.

### SUMMARY

The disclosure provides a storage system with improved performance and a method of operating the storage system.

According to an aspect of the disclosure, there is provided a method of operating a storage system including a host device, which includes a zone manager, and a storage device, the method including allocating, by the zone manager, a first essential write resource, a second essential write resource, a first spare write resource, and a second spare write resource to a first logical zone, allocating, by the zone manager, a third essential write resource, a fourth essential write resource, a third spare write resource, and a fourth spare write resource to a second logical zone, and reallocating, by the zone manager, the first spare write resource and the second spare write resource to the second logical zone.

According to another aspect of the disclosure, there is provided a storage system including a host device including a zone manager, and a storage device configured to manage a storage space in units of zones, wherein the zone manager is configured to allocate a first essential write resource and a first spare write resource to a first logical zone, the zone manager is configured to allocate a second essential write resource and a second spare write resource to a second logical zone, the zone manager is configured to reclaim the first spare write resource from the first logical zone and reallocate the first spare write resource to the second logical zone, the zone manager is configured to measure a read latency for each of the first logical zone and the second logical zone and, based on the read latency exceeding a threshold, is configured to perform a congestion control operation on a logical zone corresponding to the read latency exceeding the threshold, and the zone manager is configured to monitor an average write latency and periodically generate write tokens in each of the first logical zone and the second logical zone at each time corresponding to the average write latency.

According to another aspect of the disclosure, there is provided a method of operating a storage system including a host device including a zone manager and a storage device, the method including allocating, by the zone manager, a first physical zone and a second physical zone to a first stripe group of a first logical zone based on a first essential write resource and a first spare write resource, allocating, by the zone manager, a third physical zone and a fourth physical zone to a second stripe group of a second logical zone based on a second essential write resource and a second spare write resource, allocating, by the zone manager, a fifth physical zone to a third stripe group of the first logical zone based on the first essential write resource, and allocating, by the zone manager, a sixth physical zone, a seventh physical zone, and an eighth physical zone to a fourth stripe group of the second logical zone based on the second essential write resource, the second spare write resource, and the first spare write resource, which is reallocated from the first logical zone.

### BRIEF DESCRIPTION OF DRAWINGS

Example embodiments will be more clearly understood from the following detailed description taken in conjunction with the accompanying drawings in which:

FIG. 1 is a block diagram showing a storage system according to one or more example embodiments;

FIG. 2 is a diagram illustrating software layers of the storage system of FIG. 1;

FIG. 3 is a block diagram showing a zone manager of FIG. 1 in more detail;

FIG. 4 is a block diagram showing a storage device of FIG. 1 in more detail;

FIG. 5 is a diagram showing an example of a logical zone according to one or more example embodiments;

FIG. 6 is a diagram showing an example in which the zone manager of FIG. 1 manages a storage space of the storage device;

FIGS. 7A to 7D are diagrams illustrating write resources according to one or more example embodiments;

FIGS. 8A to 8C are diagrams showing examples of physical zones according to one or more example embodiments;

FIG. 9 is a flowchart showing an example of a method of operating the zone manager of FIG. 1;

FIG. 10 is a diagram showing an example of a local overdrive operation according to one or more example embodiments;

FIGS. 11A to 11C are diagrams showing examples of local overdrive operations according to one or more example embodiments;

FIG. 12 is a flowchart showing operation S160 of FIG. 9 in more detail;

FIG. 13 is a diagram showing an example of a method of operating the zone manager of FIG. 1;

FIG. 14 is a diagram showing an example of a write resource allocation state by a first global overdrive operation according to one or more example embodiments;

FIG. 15 is a diagram showing an example of a second logical zone by the first global overdrive operation according to one or more example embodiments;

FIG. 16 is a diagram showing an example of a method of operating the zone manager of FIG. 1;

FIG. 17 is a diagram showing an example of a write resource allocation state in a second global overdrive operation according to one or more example embodiments;

FIG. 18 is a diagram showing an example of a second logical zone in the second global overdrive operation according to one or more example embodiments;

FIG. 19 is a diagram showing an example of a fourth logical zone in the second global overdrive operation according to one or more example embodiments;

FIG. 20 is a block diagram showing a read scheduler of FIG. 3 in more detail;

FIG. 21 is a block diagram showing a write scheduler of FIG. 3 in more detail;

FIG. 22 is a diagram showing an example of software layers of the storage system of FIG. 1; and

FIG. 23 is a diagram showing an example of a logical zone according to one or more example embodiments.

### DETAILED DESCRIPTION

Hereinafter, example embodiments are described clearly and in detail so that a person skilled in the art can easily practice the disclosure.

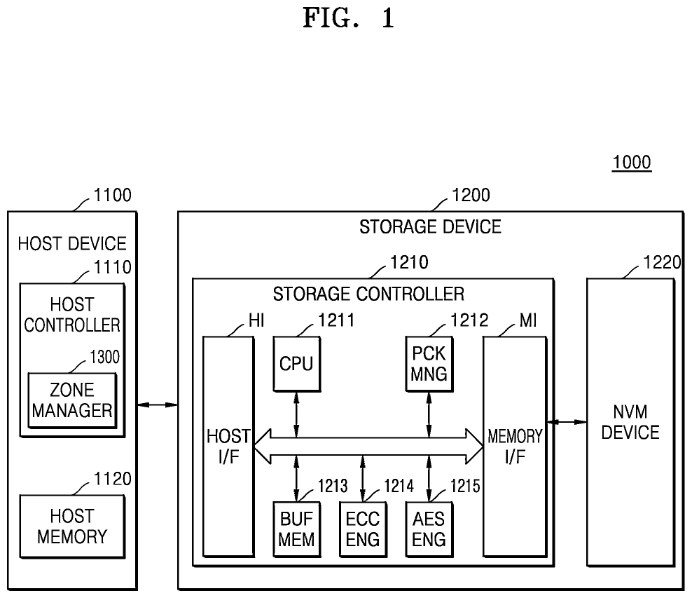

FIG. 1 is a block diagram showing a storage system 1000 according to one or more example embodiments.

Referring to FIG. 1, the storage system 1000 may include a host device 1100 and a storage device 1200. The storage device 1200 may include a storage controller 1210 and a non-volatile memory device 1220. According to one or more example embodiments, the host device 1100 may include a host controller 1110 and a host memory 1120. The host memory 1120 may function as a buffer memory for temporarily storing data to be transmitted to the storage device 1200 or data transmitted from the storage device 1200.

The storage device 1200 may include storage media for storing data in response to a request from the host device 1100. For example, the storage device 1200 may include at least one of a solid state drive (SSD), an embedded memory, and a removable external memory. When the storage device 1200 includes the SSD, the storage device 1200 may include devices that comply with non-volatile memory express (NVMe) standards. When the storage device 1200 includes the embedded memory or the external memory, the storage device 1200 may include devices that comply with universal flash storage (UFS) or embedded multi-media card (eMMC) standards. The host device 1100 and the storage device 1200 may each generate and transmit a packet according to the adopted standard protocol.

When the non-volatile memory device 1220 of the storage device 1200 includes a flash memory, the flash memory may include a two-dimensional (2D) negative-AND (NAND) memory array or a three-dimensional (3D) (or vertical) NAND (VNAND) memory array. In another example, the storage device 1200 may include various other types of a non-volatile memory. For example, the storage device 1200 may include a magnetic random access memory (MRAM), a spin-transfer torque MRAM, a conductive bridging RAM (CBRAM), a ferroelectric RAM (FeRAM), a phase RAM (PRAM), a resistive RAM, and various other types of memory.

According to one or more example embodiments, the host controller 1110 and the host memory 1120 may be provided as separate semiconductor chips. Alternatively, in some embodiments, the host controller 1110 and the host memory 1120 may be integrated into a single semiconductor chip. For example, the host controller 1110 may include any one of a plurality of modules provided in an application processor, and the application processor may be provided as a system on chip (SoC). Also, the host memory 1120 may include embedded memory provided in the application processor or include a non-volatile memory or a memory module arranged outside of the application processor.

The host controller 1110 may manage an operation of storing data (e.g., write data) of a buffer region in the non-volatile memory device 1220 or storing data (e.g., read data) of the non-volatile memory device 1220 in the buffer region.

The storage controller 1210 may include a host interface circuit HI, a memory interface circuit MI, and a central processing unit (CPU) 1211. The storage controller 1210 may further include a packet manager 1212, a buffer memory 1213, an error correction code (ECC) engine 1214, and an advanced encryption standard (AES) engine 1215.

The host interface circuit HI may transmit a packet to and receive a packet from the host device 1100. The packet transmitted from the host device 1100 to the host interface circuit HI may include a command and/or data to be written to the non-volatile memory device 1220, and the packet transmitted from the host interface circuit HI to the host device 1100 may include a response to the command and/or data read from the non-volatile memory device 1220. The memory interface circuit MI may transmit, to the non-volatile memory device 1220, data to be written to the non-volatile memory device 1220 or receive data read from the non-volatile memory device 1220. The memory interface circuit MI may be configured to comply with standard regulations, such as Toggle and open NAND flash interface (ONFI).

The ECC engine 1214 may perform error detection and/or correction function on read data that is read from the non-volatile memory device 1220. The ECC engine 1214 may perform an error detection operation and/or an error correction operation. The ECC engine 1214 may perform the error detection operation to determine whether an error exists in the data.

More specifically, the ECC engine 1214 may generate parity bits for write data to be written to the non-volatile memory device 1220, and the parity bits generated in this manner may be stored in the non-volatile memory device 1220 together with the write data. When reading data from the non-volatile memory device 1220, the ECC engine 1214 may correct an error in the read data using parity bits read from the non-volatile memory device 1220 together with the read data and may then output the read data with the error corrected.

In an embodiment, the ECC engine 1214 may use one of cyclic redundancy check (CRC) (e.g., CRC-16, CRC-32, CRC-64, CRC-128, CRC-256, etc.), hamming code, low density parity check (LDPC), bose-chaudhuri-hocquenghem (BCH) code, reed-solomon (RS) code, viterbi code, and turbo code and may perform the error detection operation and/or the error correction operation.

The AES engine 1215 may perform at least one of an encryption operation and a decryption operation on data, which is input to the storage controller 1210, using a symmetric-key algorithm.

The packet manager 1212 may generate packets according to the protocol of the interface negotiated with the host device 1100 or parse various other types of information from packets received from the host device 1100. Also, the buffer memory 1213 may temporarily store data to be written to the non-volatile memory device 1220 and/or data to be read from the non-volatile memory device 1220. The buffer memory 1213 may be provided inside the storage controller 1210 but may also be placed outside the storage controller 1210.

The storage controller 1210 may communicate with the non-volatile memory device 1220 via a plurality of channels. The non-volatile memory device 1220 may store data or output the stored data under the control by the storage controller 1210. The non-volatile memory device 1220 may include a plurality of non-volatile memories (denoted by NVM in the drawings).

The storage device 1200 may include a zoned storage device. The storage device 1200 may manage the non-volatile memory device 1220 in units of zones. For example, the storage device 1200 may manage a storage space of the non-volatile memory device 1220 in units of zones. The storage device 1200 may open a zone in response to a write request from the host device 1100. That is, the storage device 1200 may perform a zone open operation. The zone open operation may refer to an operation of allocating a new zone, in which no data is stored, so as to store data. For example, the storage device 1200 may allocate a memory block (or an erase unit) to the new zone.

The host device 1100 may perform a sequential write operation on the zone. The host device 1100 may transmit a write request for sequential logical addresses for the zone to the storage device 1200. A sequential logical address may represent a set of consecutive addresses managed by the host device 1100. The host device 1100 may not perform a random write operation on the zone.

The host controller 1110 may include a zone manager 1300. The zone manager 1300 may manage logical zones. The zone manager 1300 may manage write resources and allocate the write resources to a plurality of logical zones. The zone manager 1300 may perform a local overdrive operation. The zone manager 1300 may perform a global overdrive operation. The zone manager 1300 may perform a congestion control operation based on read latency for each zone. The zone manager 1300 may generate tokens at each time corresponding to average write latency. A token generation cycle may correspond to the average write latency. For example, the token generation cycle may be equal to the average write latency.

As described above, the zone manager 1300 may adjust a stripe width of a stripe group. The storage system 1000 may improve performance degradation caused by zones. The storage system 1000 may improve unequal performance distribution between users.

The zone manager 1300 may perform the local overdrive operation and the global overdrive operation. The zone manager 1300 may measure the read latency for each zone and perform a read latency-based congestion control operation for each zone. The zone manager 1300 may measure average write latency and adjust a token generation speed based on the average write latency. The zone manager 1300 may be provided as hardware, software, or a combination thereof configured to manage the operations described above. The operations of the zone manager 1300 are described in more detail below with reference to the drawings.

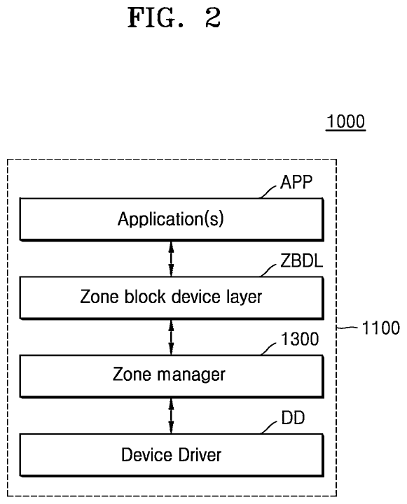

FIG. 2 is a diagram illustrating software layers of the storage system 1000 of FIG. 1.

FIGS. 1 and 2, the software layers of the storage system 1000 may include an application layer APP, a zone block device layer ZBDL, the zone manager 1300, and a device driver layer DD. The host device 1100 may include the application layer APP, the zone block device layer ZBDL, the zone manager 1300, and the device driver layer DD.

The application layer APP may include various application programs that run on the host device 1100. The application layer APP may include a plurality of applications. The plurality of applications may respectively store data in different logical zones of the storage device 1200. For example, a first application may store data in a first logical zone and a second application may store data in a second logical zone. The storage device 1200 may support a plurality of tenants. The storage system 1000 may include a multi-host storage system.

The zone block device layer ZBDL may be configured to organize files or data used by the application layer APP. For example, the zone block device layer ZBDL may manage a storage space of the storage device 1200 as a zone. The zone block device layer ZBDL may communicate (interact) with the application layer APP in namespace/logical zone management. The zone block device layer ZBDL may adjust the logical-to-physical zone mapping based on requests from the application layer APP. The zone block device layer ZBDL may schedule input/output (I/O) to achieve the maximum performance of the storage device 1200.

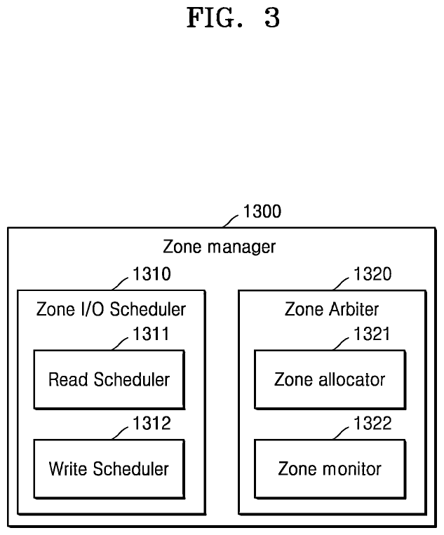

The zone manager 1300 may allocate optimal resources to a plurality of logical zones or a plurality of namespaces by dynamically reallocating write resources. The zone manager 1300 may perform the congestion control operation based on read latency for each of the zones. The zone manager 1300 may generate write tokens at each time corresponding to the average write latency and provide the write tokens to each zone. Accordingly, the storage system with improved performance may be provided. That is, the zone manager 1300 may provide uniform performance or optimal performance to the plurality of tenants or guarantee the minimum performance. The zone manager 1300 may include a zone I/O scheduler 1310 (see FIG. 3) and a zone arbiter 1320 (see FIG. 3), which will be described in detail later.

The device driver layer DD may perform an operation of converting information from the zone manager 1300, the zone block device layer ZBDL, or the application layer APP into information identifiable by the storage device 1200. In an embodiment, the application layer APP, the zone block device layer ZBDL, the zone manager 1300, and the device driver layer DD may be provided as software and run on the host device 1100. In an embodiment, the application layer APP may be configured to transmit an I/O request for the zone to the storage device 1200. However, the scope of the disclosure is not limited thereto, and the zone block device layer ZBDL, the zone manager 1300, or the device driver layer DD may be configured to transmit the I/O request for the zone to the storage device 1200.

As described above, the storage system 1000 may dynamically distribute resources to logical zones. The storage system 1000 may ensure optimized performance by using an I/O scheduler. The storage system 1000 may ensure equal performance between applications by using the I/O scheduler. The storage system 1000 may maximize a performance rate of the storage device 1200 regardless of the number of applications or characteristics of workloads. The storage system 1000 may provide the optimized performance.

FIG. 3 is a block diagram showing the zone manager 1300 of FIG. 1 in more detail.

Referring to FIGS. 1 and 3, the zone manager 1300 may include the zone I/O scheduler 1310 and the zone arbiter 1320.

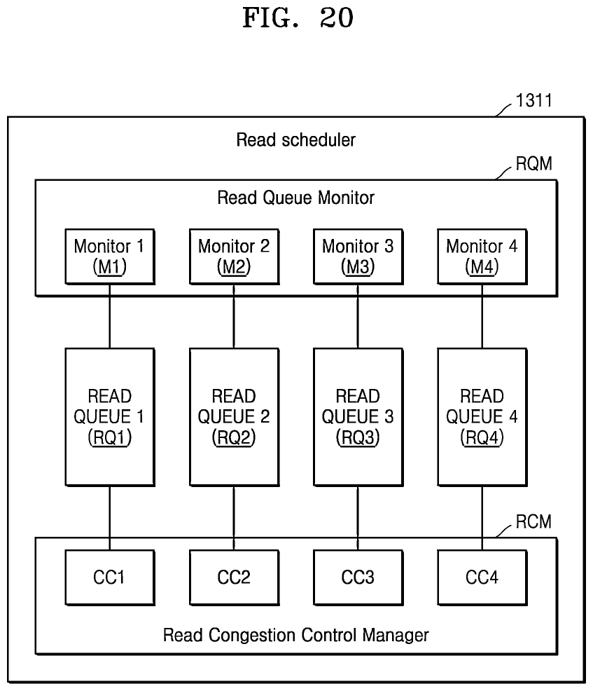

In an embodiment, the zone I/O scheduler 1310 may include a read scheduler 1311 and a write scheduler 1312. The read scheduler 1311 may monitor read latency for each logical zone. The read scheduler 1311 may perform the congestion control operation for each logical zone based on the read latency. The configuration and operation method of the read scheduler 1311 are described below in more detail with reference to FIG. 20.

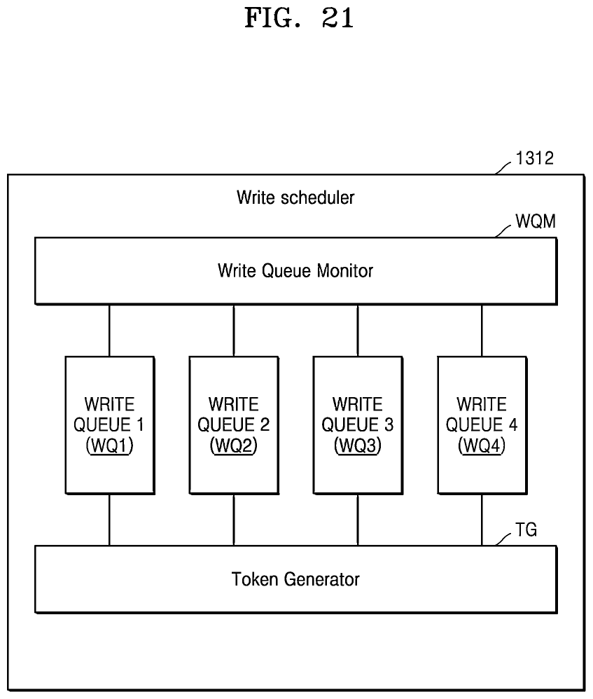

The write scheduler 1312 may monitor average write latency for all logical zones. The write scheduler 1312 may generate a token based on the average write latency. The configuration and operation method of the write scheduler 1312 are described below in more detail with reference to FIG. 21.

In an embodiment, the zone arbiter 1320 may include a zone allocator 1321 and a zone monitor 1322. The zone allocator 1321 may allocate write resources to logical zones. The zone allocator 1321 may allocate the physical zones to the stripe group based on the write resources. The zone allocator 1321 may perform a stripe group open operation. The zone allocator 1321 may perform a stripe group close operation. The zone allocator 1321 may perform an overdrive operation. The overdrive operation may represent an operation of additionally allocating resources other than initially allocated resources and/or an operation of reclaiming some of the initially allocated resources.

The zone monitor 1322 may monitor a resource utilization rate of the storage device 1200. The zone monitor 1322 may measure a write resource utilization rate in a previous stripe group (e.g., a stripe group on which a write operation has been performed) based on whether more write resources are required. The zone monitor 1322 may measure a write resource utilization rate in a previous stripe group based on whether less write resources are required. The zone monitor 1322 may determine whether a namespace or a logical zone is in an inactive state. The zone monitor 1322 may determine whether a namespace or a logical zone is in a suspended state. For example, the inactive state may represent a state in which data has never been stored. The suspended state may represent a state in which a write request has not been received for a certain period of time (or beyond a certain period of time) after data was stored.

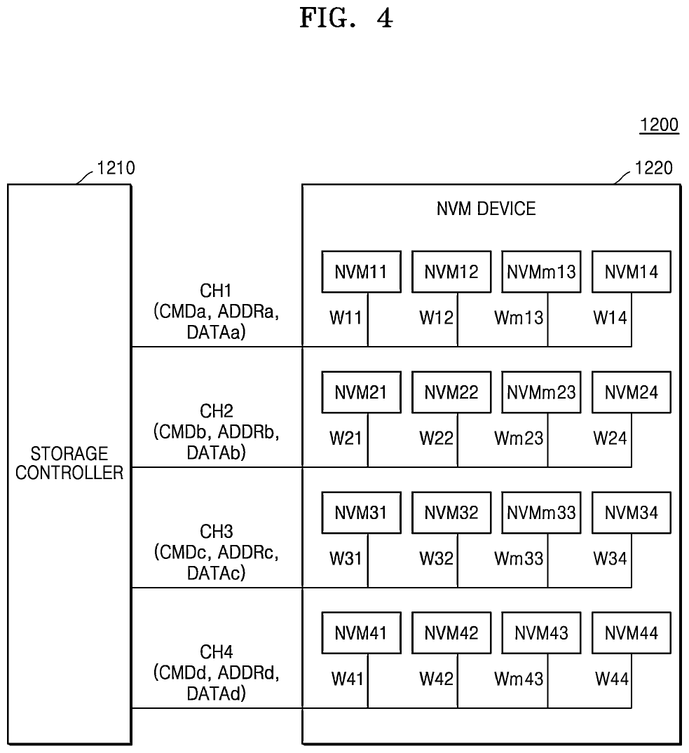

FIG. 4 is a block diagram showing the storage device 1200 of FIG. 1 in more detail.

Referring to FIG. 4, the storage device 1200 may include the non-volatile memory device 1220 and the storage controller 1210. The storage device 1200 may support a plurality of channels CH1 to CH4, and the non-volatile memory device 1220 and the storage controller 1210 may be connected to each other via the plurality of channels CH1 to CH4 (or hereinafter referred to as the first to fourth channels CH1 to CH4). For example, the storage device 1200 may be provided as a storage device, such as an SSD.

The non-volatile memory device 1220 may include a plurality of non-volatile memories NVM11 to NVM44. The non-volatile memories NVM11 to NVM44 may be respectively connected to the plurality of channels CH1 to CH4 via corresponding ways. For example, the non-volatile memories NVM11 to NVM14 may be connected to the first channel CH1 via ways W11 to W14, respectively. The non-volatile memory devices NVM21 to NVM24 may be connected to the second channel CH2 via ways W21 to W24, respectively. The non-volatile memory devices NVM31 to NVM34 may be connected to the third channel CH3 via ways W31 to W34, respectively, and the non-volatile memory devices NVM41 to NVM44 may be connected to the fourth channel CH4 via ways W41 to W44, respectively.

For example, each of the non-volatile memories NVM11 to NVM44 may be provided as an arbitrary memory unit that may operate according to individual instructions from the storage controller 1210. For example, each of the non-volatile memories NVM11 to NVM44 may be provided as a chip or die, but the embodiment is not limited thereto.

The storage controller 1210 may transmit signals to or receive signals from the non-volatile memory device 1220 via the plurality of channels CH1 to CH4. For example, the storage controller 1210 may transmit commands CMDa to CMDd, addresses ADDRa to ADDRd, and data DATAa to DATAd to the non-volatile memory device 1220 via the channels CH1 to CH4 or may receive data DATAa to DATAd from the non-volatile memory device 1220.

The storage controller 1210 may select one of the non-volatile memories NVM11 to NVM44 connected to a channel through the corresponding channel and may transmit signals to and receive signals from the selected non-volatile memory device. For example, the storage controller 1210 may select the non-volatile memory NVM11 connected to the first channel CH1 among the non-volatile memories NVM11 to NVM14. The storage controller 1210 may transmit the command CMDa, the address ADDRa, and the data DATAa to the selected non-volatile memory NVM11 via the first channel CH1 or may receive the data DATAa from the selected non-volatile memory NVM11.

The storage controller 1210 may transmit signals to and receive signals from the non-volatile memory device 1220 in parallel via different channels. For example, the storage controller 1210 may transmit the command CMDb to the non-volatile memory device 1220 via the second channel CH2 while transmitting the command CMDa to the non-volatile memory device 1220 via the first channel CH1. For example, the storage controller 1210 may receive the data DATAb from the non-volatile memory device 1220 via the second channel CH2 while receiving the data DATAa from the non-volatile memory device 1220 via the first channel CH1.

The storage controller 1210 may control all operations of the non-volatile memory device 1220. The storage controller 1210 may control each of the non-volatile memories NVM11 to NVM44 connected to the channels CH1 to CH4 by transmitting signals via the channels CH1 to CH4. For example, the storage controller 1210 may control a selected one of the non-volatile memories NVM11 to NVM14 by transmitting the command CMDa and the address ADDRa via the first channel CH1.

Each of the non-volatile memories NVM11 to NVM44 may operate under the control by the storage controller 1210. For example, the non-volatile memory NVM11 may program the data DATAa according to the command CMDa and the address ADDRa provided via the first channel CH1. For example, the non-volatile memory NVM21 may read the data DATAb according to the command CMDb and the address ADDRb provided via the second channel CH2 and may transmit the read data DATAb to the storage controller 1210.

FIG. 4 illustrates that the non-volatile memory device 1220 communicates with the storage controller 1210 via the four channels and the non-volatile memory device 1220 includes the four non-volatile memories corresponding to each channel. However, the number of channels and the number of non-volatile memory devices connected to one channel may be changed diversely.

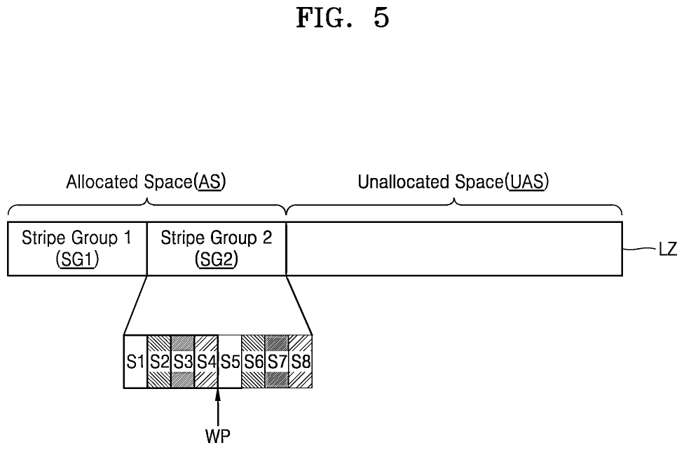

FIG. 5 is a diagram showing an example of a logical zone LZ according to one or more example embodiments.

Referring to FIGS. 1 and 5, the logical zone LZ may include an allocated space AS and an unallocated space UAS. The allocated space AS may represent a space of the logical zone LZ, to which physical zones are allocated. The unallocated space UAS may represent a space of the logical zone LZ, to which physical zones are not allocated. Alternatively, the unallocated space UAS may represent a space to which a physical zone is allocated in the future.

The allocated space AS may include a plurality of stripe groups SG1 and SG2 (or referred to as a first stripe group SG1 and a second stripe group SG2). For example, the allocated space AS of the first logical zone may include the first stripe group SG1 and the second stripe group SG2. However, the scope of the disclosure is not limited thereto, and the number of stripe groups in the allocated space AS may be decreased or increased according to embodiments or situations.

The first stripe group SG1 may include a completed stripe group. The first stripe group SG1 may be in a closed state. The second stripe group SG2 may include an activated stripe group. The second stripe group SG2 may be in an open state. The zone manager 1300 may write data to the activated stripe group. Each of the stripe groups SG1 and SG2 may include a plurality of stripes. For example, the second stripe group SG2 may include first to eighth stripes S1 to S8.

In an embodiment, the first stripe group SG1 may be in the closed state, and thus, data may be stored in all stripes of the first stripe group SG1. Alternatively, in an embodiment, even if a write pointer of the first stripe group SG1 does not reach the end of the first stripe group SG1, the first stripe group SG1 may be changed to the closed state. In an embodiment, even if all data is not stored in the first stripe group SG1, the first stripe group SG1 may be changed to the closed state in response to a request from the application layer APP.

The second stripe group SG2 may be in the open state, and data may be stored in the first to fourth stripes S1 to S4 among the stripes of the second stripe group SG2. Data may be next stored in the fifth to eighth stripes S5 to S8 of the second stripe group SG2. A write pointer WP may point to an end of the fourth stripe S4. That is, the write pointer WP may point to the fifth stripe S5. Data to be stored next may be stored in the fifth stripe S5.

The zone manager 1300 may perform a stripe group open operation. The stripe group open operation may represent an operation of allocating a physical zone to the stripe group based on write resources. When reaching an end of a previous stripe group, the zone manager 1300 may allocate a new stripe group to the logical zone. The zone manager 1300 may change the state of the new stripe group from closed to open. For example, the closed state may represent a state in which a write operation may not be performed. Alternatively, the closed state may represent a state in which physical zones are not allocated to the stripe group. The open state may represent a state in which a write operation may be performed. Alternatively, the open state may indicate a state in which physical zones are allocated to the stripe group.

When the write pointer WP reaches the end of the stripe group, the zone manager 1300 may perform the stripe group close operation. The stripe group close operation may represent an operation of reclaiming reallocated write resources. The zone manager 1300 may change the status of the previous stripe group from open to closed.

When the write pointer WP reaches the end of the previous stripe group (e.g., the first stripe group SG1), the physical zones of the previous stripe group may be completed. That is, the data has been stored in all physical zones of the previous stripe group, and thus, there may be no more space to store new data in the previous stripe group.

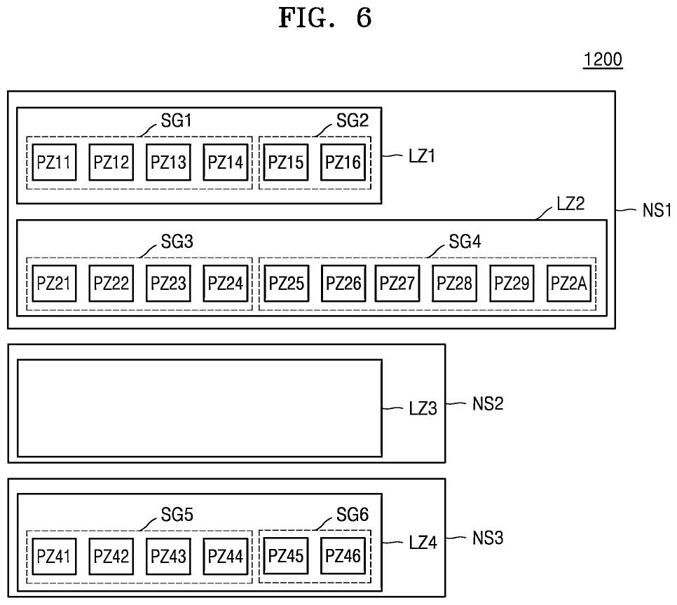

FIG. 6 is a diagram showing an example in which the zone manager of FIG. 1 manages a storage space of the storage device.

Referring to FIGS. 1 and 6, the storage device 1200 may include first to third namespaces NS1 to NS3. The namespace may represent a logically or physically separated storage region in the storage device 1200.

In an embodiment, the first namespace NS1 may include a first logical zone LZ1 and a second logical zone LZ2. The second namespace NS2 may include a third logical zone LZ3. The third namespace NS3 may include a fourth logical zone LZ4.

The first logical zone LZ1 may include a first stripe group SG1 and a second stripe group SG2. The first stripe group SG1 may be in a closed state and the second stripe group SG2 may be in an open state. The second logical zone LZ2 may include a third stripe group SG3 and a fourth stripe group SG4. The third stripe group SG3 may be in a closed state and the fourth stripe group SG4 may be in an open state.

The third logical zone LZ3 may not include a stripe group. The third logical zone LZ3 may be in an inactive state. The third logical zone LZ3 may not have received a write request and thus not performed a stripe group open operation. The fourth logical zone LZ4 may include a fifth stripe group SG5 and a sixth stripe group SG6. The fifth stripe group SG5 may be in a closed state and the sixth stripe group SG6 may be in an open state.

The first stripe group SG1 may include physical zones PZ11, PZ12, PZ13, and PZ14. The second stripe group SG2 may include physical zones PZ15 and PZ16. The third stripe group SG3 may include physical zones PZ21, PZ22, PZ23, and PZ24. The fourth stripe group SG4 may include physical zones PZ25, PZ26, PZ27, PZ28, PZ29, and PZ2A. The fifth stripe group SG5 may include physical zones PZ41, PZ42, PZ43, and PZ44. The sixth stripe group SG6 may include physical zones PZ45 and PZ46.

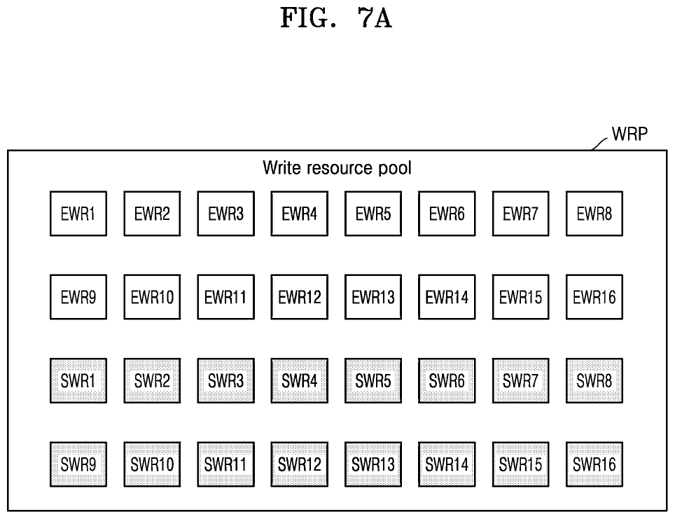

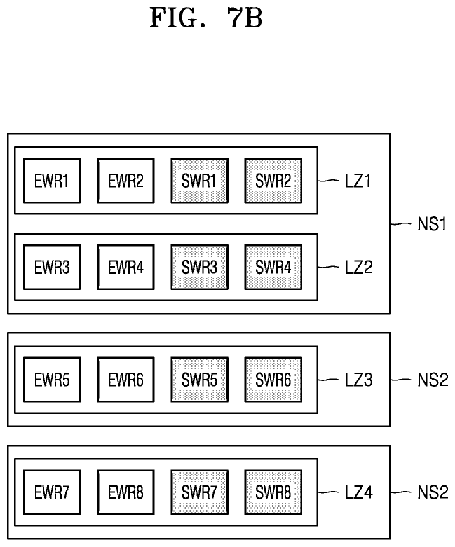

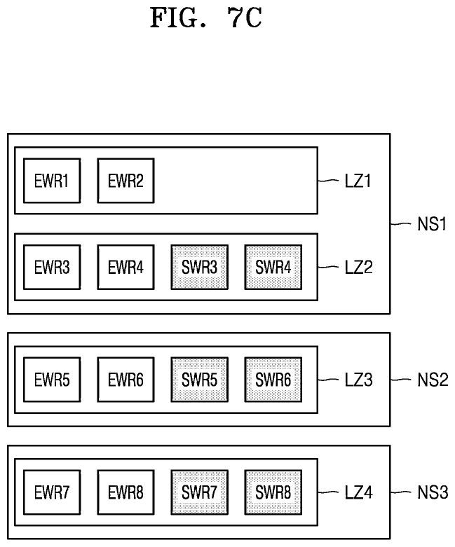

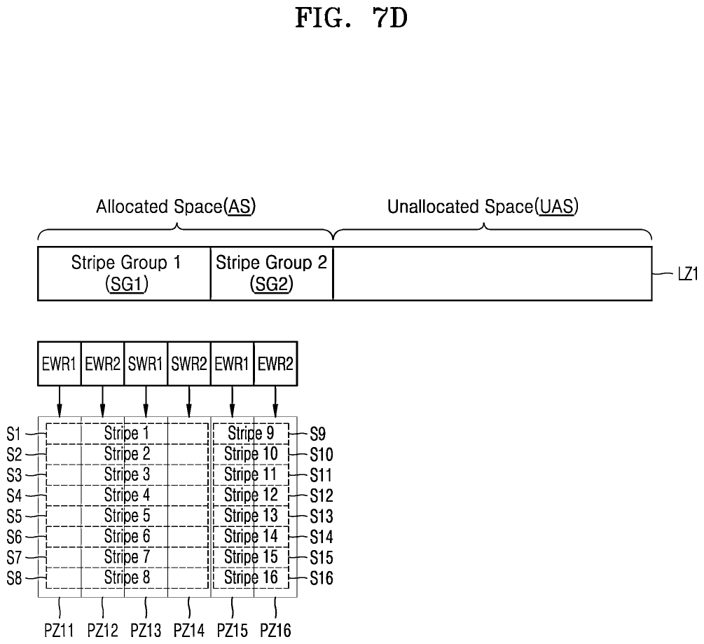

FIGS. 7A to 7D are diagrams illustrating write resources according to one or more example embodiments.

FIG. 7A is a diagram showing a write resource pool. FIG. 7B is a diagram showing a write resource allocation state when a first stripe group SG1 of a first logical zone LZ1 is in an open state. FIG. 7C is a diagram showing a write resource allocation state when a second stripe group SG2 of the first logical zone LZ1 is in an open state. FIG. 7D is a diagram illustrating the relationship between write resources and physical zones.

Referring to FIG. 7A, the zone manager 1300 may create a write resource pool WRP and manage the write resource pool WRP. The write resource pool WRP may include write resources. For example, the write resource may represent an active physical zone. The write resources may be classified into essential write resources and spare write resources. That is, the write resource pool WRP may include essential write resources EWR and spare write resources SWR.

For example, the essential write resources EWR may represent write resources that are not used for overdrive operations. The essential write resources EWR may include resources to ensure minimum performance. The essential write resources EWR may represent resources that are not reclaimed during an operation after being allocated to a logical zone. The spare write resources SWR may represent write resources that are used for overdrive operations. The spare write resources SWR may represent resources that may be reclaimed during an operation after being allocated to a logical zone.

For example, the write resource pool WRP may include first to sixteenth essential write resources EWR1 to EWR16 and first to sixteenth spare write resources SWR1 to SWR16. However, the scope of the disclosure is not limited thereto, and the number of essential write resources EWR and the number of spare write resources SWR may be increased or decreased according to embodiments. The total number of write resources, including the essential write resources EWR and the spare write resources SWR, may be determined based on whether a backup operation is possible without data (or metadata) loss when unexpected power-off occurs on the storage device. The number of essential write resources EWR may correspond to a minimum number of physical regions that may maximize a bandwidth of the storage device 1200. The number of spare write resources SWR may be determined based on the total number of write resources and the number of essential write resource EWR. The number of spare write resources SWR may correspond to a value obtained by subtracting the number of essential write resources EWR from the total number of write resources.

In an embodiment, the number of all write resources of the write resource pool WRP may correspond to a multiple of the number of non-volatile memories NVM11 to NVM44 of the non-volatile memory device 1220. That is, the number of write resources may correspond to a multiple of the total number of dies in the storage device 1200.

Referring to FIG. 7B, the storage device 1200 may include first to third namespaces NS1 to NS3. The first namespace NS1 may include first and second logical zones LZ1 and LZ2. The second namespace NS2 may include a third logical zone LZ3. The third namespace NS3 may include a fourth logical zone LZ4.

The zone manager 1300 may allocate write resources to logical zones. In an embodiment, the zone manager 1300 may equally allocate the write resources to each of the logical zones. The zone manager 1300 may allocate at least one essential write resource to each of logical zones LZ. The zone manager 1300 may not allocate a spare write resource to each of the logical zones LZ. Also, the zone manager 1300 may allocate at least one spare write resource to each of the logical zones LZ.

For example, the zone manager 1300 may allocate, to the first logical zone LZ1, the first essential write resource EWR1, the second essential write resource EWR2, the first spare write resource SWR1, and the second spare write resource SWR2. The zone manager 1300 may allocate, to the second logical zone LZ2, a third essential write resource EWR3, a fourth essential write resource EWR4, a third spare write resource SWR3, and a fourth spare write resource SWR4. The zone manager 1300 may allocate, to the third logical zone LZ3, a fifth essential write resource EWR5, a sixth essential write resource EWR6, a fifth spare write resource SWR5, and a sixth spare write resource SWR6. The zone manager 1300 may allocate, to the fourth logical zone LZA, a seventh essential write resource EWR7, an eighth essential write resource EWR8, a seventh spare write resource SWR7, and an eighth spare write resource SWR8. However, the scope of the disclosure is not limited thereto, and the number of allocated essential write resources EWR and the number of allocated spare write resources SWR may be reduced or increased according to embodiments.

Referring to FIG. 7C, the zone manager 1300 may reclaim the allocated write resources. For example, the zone manager 1300 may reclaim spare write resources from the first logical zone LZ1. The zone manager 1300 may reclaim the first spare write resource SWR1 and the second spare write resource SWR2 from the first logical zone LZ1. Accordingly, the first logical zone LZ1 may have (or own) the first essential write resource EWR1 and the second essential write resource EWR2. The second logical zone LZ2 may have the third essential write resource EWR3, the fourth essential write resource EWR4, the third spare write resource SWR3, and the fourth spare write resource SWR4. The third logical zone LZ3 may have the fifth essential write resource EWR5, the sixth essential write resource EWR6, the fifth spare write resource SWR5, and the sixth spare write resource SWR6. The fourth logical zone LZ4 may have the seventh essential write resource EWR7, the eighth essential write resource EWR8, the seventh spare write resource SWR7, and the eighth spare write resource SWR8.

Referring to FIG. 7D, the first logical zone LZ1 may include a first stripe group SG1, a second stripe group SG2, and an unallocated space UAS. As shown in FIG. 7B, when the first stripe group SG1 is in the open state, the first logical zone LZ1 may have the first essential write resource EWR1, the second essential write resource EWR2, the first spare write resource SWR1, and the second spare write resource SWR2. Accordingly, the zone manager 1300 may allocate first to fourth physical zones PZ11 to PZ14 to the first stripe group SG1. The zone manager 1300 may allocate the first physical zone PZ11 corresponding to the first essential write resource EWR1, the second physical zone PZ12 corresponding to the second essential write resource EWR2, the third physical zone PZ13 corresponding to the first spare write resource SWR1, and the fourth physical zone PZ14 corresponding to the second spare write resource SWR2. That is, the first stripe group SG1 may include the first to fourth physical zones PZ11 to PZ14.

As shown in FIG. 7C, when the second stripe group SG2 is in the open state, the first logical zone LZ1 may have the first essential write resource EWR1 and the second essential write resource EWR2. Accordingly, the zone manager 1300 may allocate fifth and sixth physical zones PZ15 and PZ16 to the second stripe group SG2. The zone manager 1300 may allocate the fifth physical zone PZ15 corresponding to the first essential write resource EWR1 and the sixth physical zone PZ16 corresponding to the second essential write resource EWR2. That is, the second stripe group SG2 may include the fifth and sixth physical zones PZ15 and PZ16.

In an embodiment, the zone manager 1300 may allocate, to a stripe group SG, physical zones as many as a sum of the number of essential write resources and the number of spare write resources. The zone manager 1300 may determine a stripe width based on the number of essential write resources and the number of spare write resources. The stripe width may be calculated by adding the number of essential write resources and the number of spare write resources. The stripe width may correspond to the result of performing an addition operation on the number of essential write resources and the number of spare write resources. The zone manager 1300 may allocate, to the stripe group, physical zones as many as a value of the stripe width.

For example, when the first stripe group SG1 is in an open state, the number of essential write resources in the first logical zone LZ1 is ‘2’ and the number of spare write resources in the first logical zone LZ1 is ‘2.’ Accordingly, the stripe width of the first stripe group SG1 may be ‘4.’ The zone manager 1300 may allocate, to the first stripe group SG1, the physical zones PZ11, PZ12, PZ13, and PZ14 of which number corresponds to the stripe width. The number (e.g., ‘4’) of physical zones in the first stripe group SG1 may be equal to the stripe width (e.g., ‘4’) of the first stripe group SG1.

For example, when the second stripe group SG2 is in an open state, the number of essential write resources in the first logical zone LZ1 is ‘2’ and the number of spare write resources in the first logical zone LZ1 is ‘0.’ Accordingly, the stripe width of the second stripe group SG2 may be ‘2.’ The zone manager 1300 may allocate, to the second stripe group SG2, the physical zones PZ15 and PZ16 of which number corresponds to the stripe width. The number (e.g., ‘2’) of physical zones in the second stripe group SG2 may be equal to the stripe width (e.g., ‘2’) of the second stripe group SG2.

The stripe group SG may include a plurality of stripes. For example, the first stripe group SG1 may include first to eighth stripes S1 to S8. The second stripe group SG2 may include ninth to sixteenth stripes S9 to S16. Each of the first to eighth stripes S1 to S8 may be stored in the first to fourth physical zones PZ11 to PZ14. Each of the ninth to sixteenth stripes S9 to S16 may be stored in the fifth and sixth physical zones PZ15 and PZ16.

As described above, the first logical zone LZ1 may include the first stripe group SG1 in the closed state and the second stripe group SG2 in the open state. The first stripe group SG1 may include the first physical zone PZ11 corresponding to the first essential write resource EWR1, the second physical zone PZ12 corresponding to the second essential write resource EWR2, the third physical zone PZ13 corresponding to the first spare write resource SWR1, and the fourth physical zone PZ14 corresponding to the second spare write resource SWR2. The second stripe group SG2 may include the fifth physical zone PZ15 corresponding to the first essential write resource EWR1 and the sixth physical zone PZ16 corresponding to the second essential write resource EWR2. In the storage device 1200, a first portion of the first data for the first logical zone LZ1 may be stored in the fifth physical zone PZ15, and a second portion of the first data for the first logical zone LZ1 may be stored in the sixth physical zone PZ16.

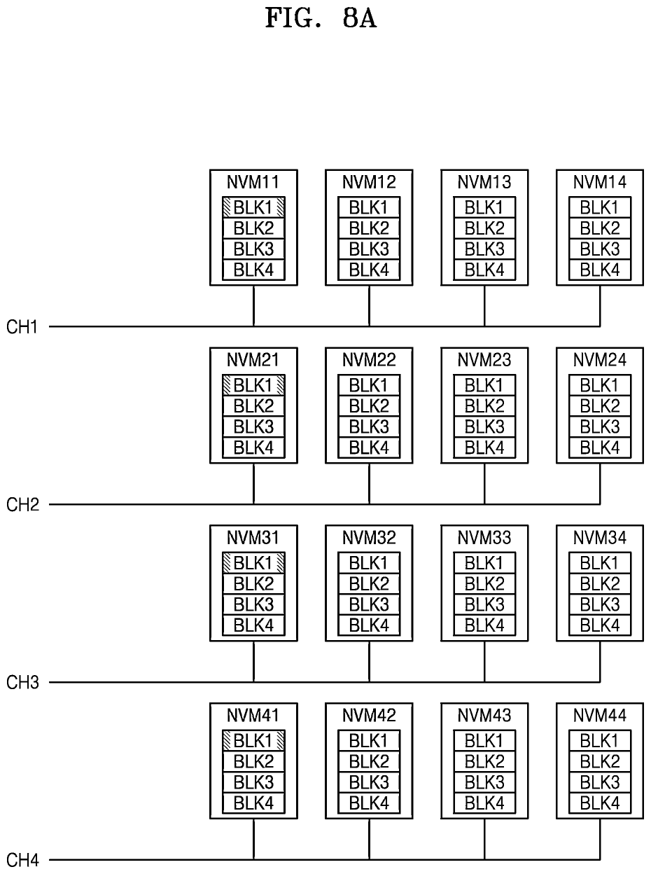

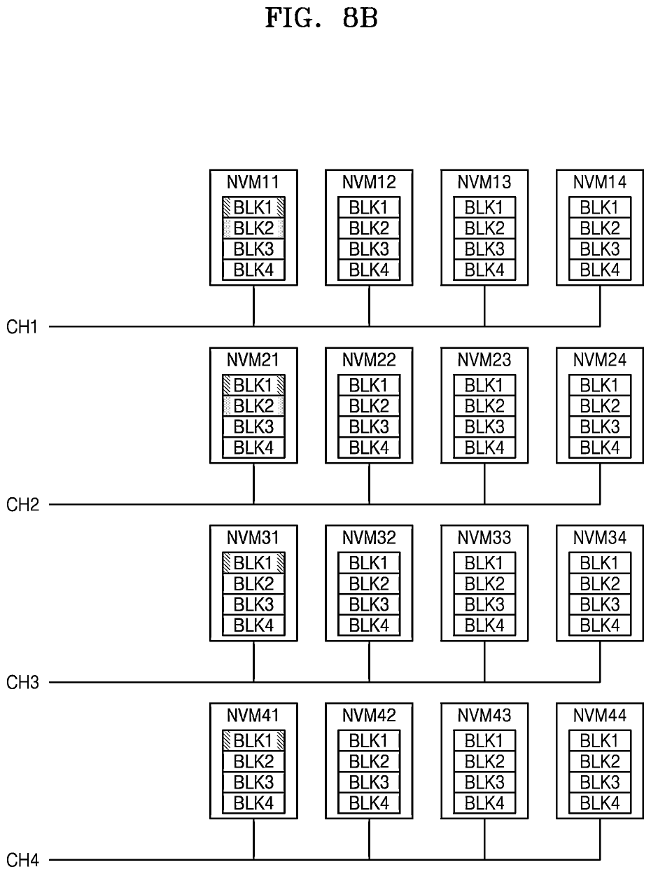

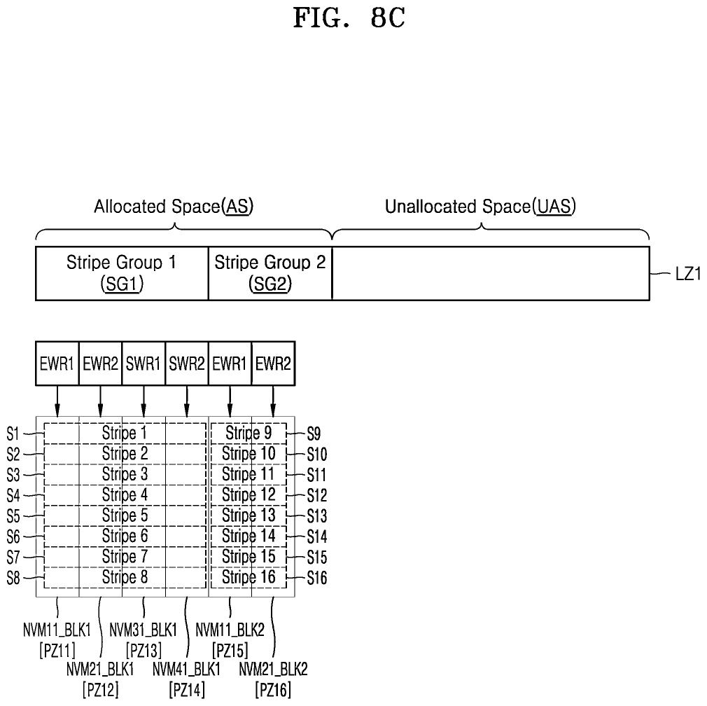

FIGS. 8A to 8C are diagrams showing examples of physical zones according to one or more example embodiments.

FIG. 8A is a diagram showing the arrangement of physical zones when a first stripe group SG1 of FIG. 8C is in an open state. FIG. 8B is a diagram showing the arrangement of physical zones when a second stripe group SG2 of FIG. 8C is in an open state. FIG. 8C is a diagram illustrating the relationship between write resources and physical zones.

In an embodiment, the physical zone may represent a small zone. The physical zone may include one or more erase units (or erase blocks, memory blocks) on one die (e.g., one non-volatile memory). That is, the physical zone may include at least one memory block. For example, a physical zone PZ may correspond to one memory block BLK of the storage device 1200. However, the scope of the disclosure is not limited thereto, and the number of memory blocks in the physical zone may be reduced or increased according to embodiments.

Referring to FIGS. 8A to 8C, while the first stripe group SG1 of the first logical zone LZ1 is in an open state, the stripe width may be ‘4.’ The first logical zone LZ1 may have a first essential write resource EWR1, a second essential write resource EWR2, a first spare write resource SWR1, and a second spare write resource SWR2. Accordingly, the zone manager 1300 may allocate first to fourth physical zones PZ11 to PZ14 to the first stripe group SG1. The first physical zone PZ11 may correspond to a first memory block BLK1 of a first non-volatile memory NVM11 connected to a first channel CH1. The second physical zone PZ12 may correspond to a first memory block BLK1 of a second non-volatile memory NVM21 connected to a second channel CH2. The third physical zone PZ13 may correspond to a first memory block BLK1 of a third non-volatile memory NVM31 connected to a third channel CH3. The fourth physical zone PZ14 may correspond to a first memory block BLK1 of a fourth non-volatile memory NVM41 connected to a fourth channel CH4.

Accordingly, while the first stripe group SG1 is in the open state, the storage device 1200 may store the data for the first logical zone LZ1 in the first memory block BLK1 of the first non-volatile memory NVM11, the first memory block BLK1 of the second non-volatile memory NVM21, the first memory block BLK1 of the third non-volatile memory NVM31, and the first memory block BLK1 of the fourth non-volatile memory NVM41.

The first memory block BLK1 of the first non-volatile memory NVM11 may correspond to the first essential write resource EWR1, the first memory block BLK1 of the second non-volatile memory NVM21 may correspond to the second essential write resource EWR2, the first memory block BLK1 of the third non-volatile memory NVM31 may correspond to the first spare write resource SWR1, and the first memory block BLK1 of the fourth non-volatile memory NVM41 may correspond to the second spare write resource SWR2. The first stripe group SG1 may include first to eighth stripes S1 to S8. The first to eighth stripes S1 to S8 may be stored in the first memory block BLK1 of the first non-volatile memory NVM11, the first memory block BLK1 of the second non-volatile memory NVM21, the first memory block BLK1 of the third non-volatile memory NVM31, and the first memory block BLK1 of the fourth non-volatile memory NVM41. For example, a first portion of the first stripe S1 may be stored in the first memory block BLK1 of the first non-volatile memory NVM11, a second portion of the first stripe S1 may be stored in the first memory block BLK1 of the second non-volatile memory NVM21, a third portion of the first stripe S1 may be stored in the first memory block BLK1 of the third non-volatile memory NVM31, and a fourth portion of the first stripe S1 may be stored in the first memory block BLK1 of the fourth non-volatile memory NVM41.

While the second stripe group SG2 of the first logical zone LZ1 is in an open state, the stripe width may be ‘2.’ The first logical zone LZ1 may have the first essential write resource EWR1 and the second essential write resource EWR2. Accordingly, the zone manager 1300 may allocate fifth and sixth physical zones PZ15 and PZ16 to the second stripe group SG2. The fifth physical zone PZ15 may correspond to a second memory block BLK2 of the first non-volatile memory NVM11 connected to the first channel CH1. The sixth physical zone PZ16 may correspond to a second memory block BLK2 of the second non-volatile memory NVM21 connected to the second channel CH2.

Accordingly, while the second stripe group SG2 is in the open state, the storage device 1200 may store data for the first logical zone LZ1 in the second memory block BLK2 of the first non-volatile memory NVM11 and the second memory block BLK2 of the second non-volatile memory NVM21.

The second memory block BLK2 of the first non-volatile memory NVM11 may correspond to the first essential write resource EWR1, and the second memory block BLK2 of the second non-volatile memory NVM21 may correspond to the second essential write resource EWR2. The second stripe group SG2 may include ninth to sixteenth stripes S9 to S16. The ninth to sixteenth stripes S9 to S16 may be stored in the second memory block BLK2 of the first non-volatile memory NVM11 and the second memory block BLK2 of the second non-volatile memory NVM21. For example, a first portion of the ninth stripe S9 may be stored in the second memory block BLK2 of the first non-volatile memory NVM11, and a second portion of the ninth stripe S9 may be stored in the second memory block BLK2 of the second non-volatile memory NVM21.

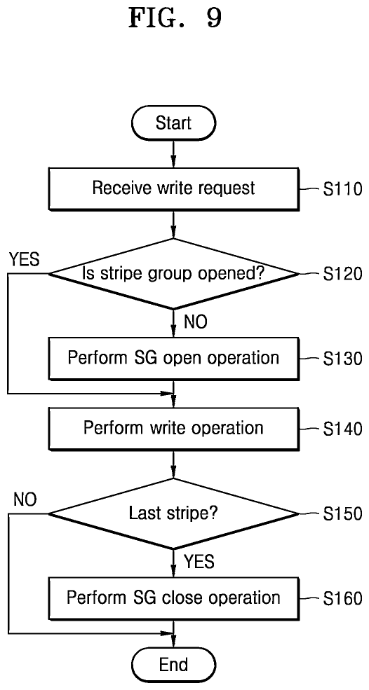

FIG. 9 is a flowchart showing an example of a method of operating the zone manager 1300 of FIG. 1.

Referring to FIGS. 1 and 9, in operation S110, the zone manager 1300 may receive a write request from an application layer APP. For example, the zone manager 1300 may receive a write request for a first logical zone LZ1.

In operation S120, the zone manager 1300 may determine whether a stripe group of the first logical zone LZ1 is in an open state. The zone manager 1300 may perform operation S140 when the stripe group is open and perform operation S130 when the stripe group is not open. For example, the zone manager 1300 may determine whether the stripe group of the first logical zone LZ1 is in an open state.

In operation S130, the zone manager 1300 may perform a stripe group open operation for the stripe group of the first logical zone LZ1. When the stripe group is not open (i.e., closed), the zone manager 1300 may perform the stripe group open operation of allocating physical zones for the stripe group. For example, the zone manager 1300 may perform the stripe group open operation for a first stripe group SG1 of the first logical zone LZ1.

In operation S140, the zone manager 1300 may perform a write operation. For example, the zone manager 1300 may transmit a write request to physical zones allocated to a stripe group SG. For example, when the stripe group is in an open state, the zone manager 1300 may perform the write operation on the stripe group in the open state. The zone manager 1300 may write data to the physical zones of the stripe group. When the stripe group is not in the open state (‘No’ in operation S120), the zone manager 1300 may perform the stripe group open operation on the stripe group so as to change the stripe group from the closed state to the open state and may then perform the write operation on the stripe group in the open state.

In operation S150, the zone manager 1300 may determine whether a current stripe is the last stripe of the stripe group. The zone manager 1300 may determine whether the write operation has been performed on a last stripe in the stripe group. The zone manager 1300 may determine whether a write pointer WP has reached the end of the stripe group SG. The zone manager 1300 may determine whether data on which a write operation has been performed is stored in the last stripe of the stripe group. The zone manager 1300 may determine whether the stripe group is completely filled with data. The zone manager 1300 may determine whether there is no more space to write data in the physical zones of the stripe group. The zone manager 1300 may perform operation S160 if the stripe is the last stripe and may increase the write pointer WP if the stripe is not the last stripe.

In operation S160, the zone manager 1300 may perform a stripe group close operation. The zone manager 1300 may perform a stripe group close operation based on determining that the write operation has been performed on the last stripe. The zone manager 1300 may change the status of the stripe group SG from open to closed. In an embodiment, the zone manager 1300 may return reallocated spare write resources upon the status of the stripe group SG being changed from open to closed.

As described above, the zone manager 1300 may receive a write request for the first logical zone LZ1. When the stripe group SG of the first logical zone LZ1 is not in an open state, the zone manager 1300 may perform a stripe group open operation of the first logical zone LZ1. When the stripe group of the first logical zone LZ1 is in the open state, the zone manager 1300 may perform the write operation with respect to the stripe group of the first logical zone LZ1. After performing the write operation, the zone manager 1300 may determine whether a stripe is the last stripe in the stripe group of the first logical zone LZ1. The zone manager 1300 may perform a stripe group close operation with respect to the stripe group of the first logical zone LZ1 when the stripe is the last stripe of the first logical zone LZ1.

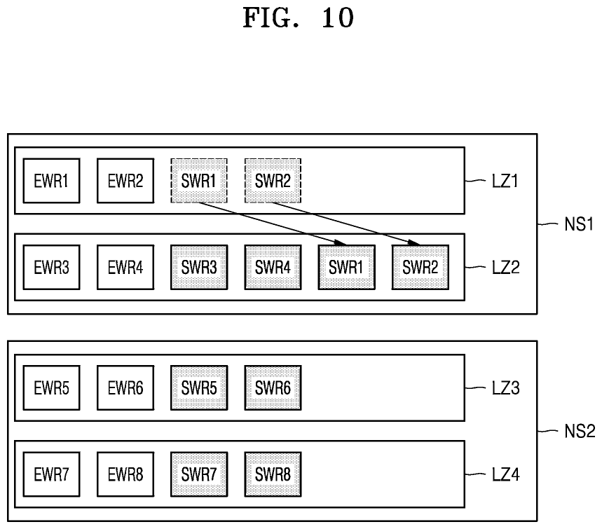

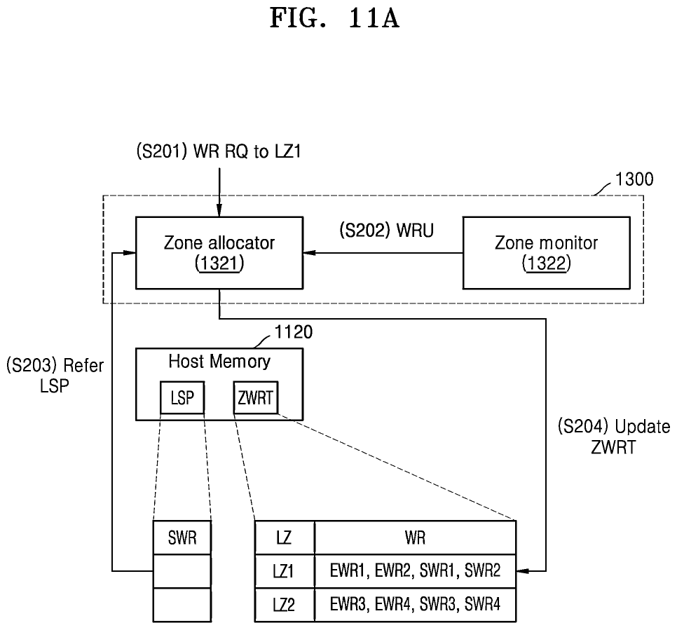

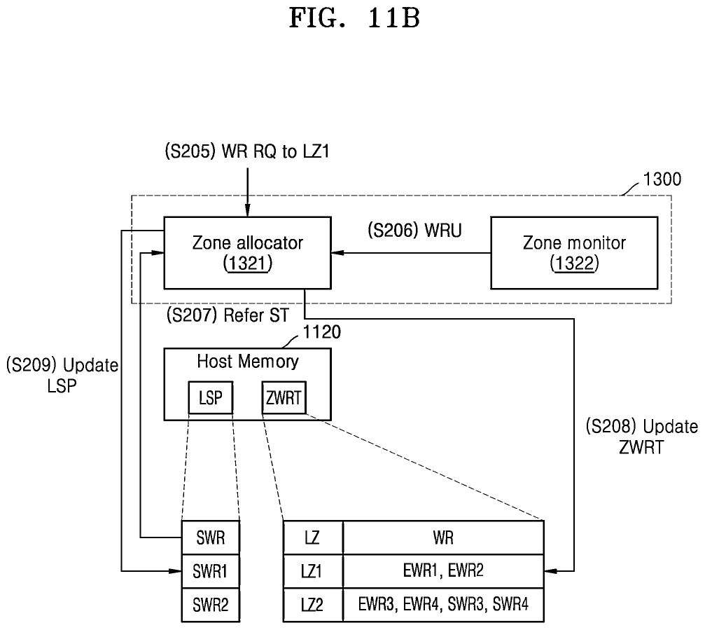

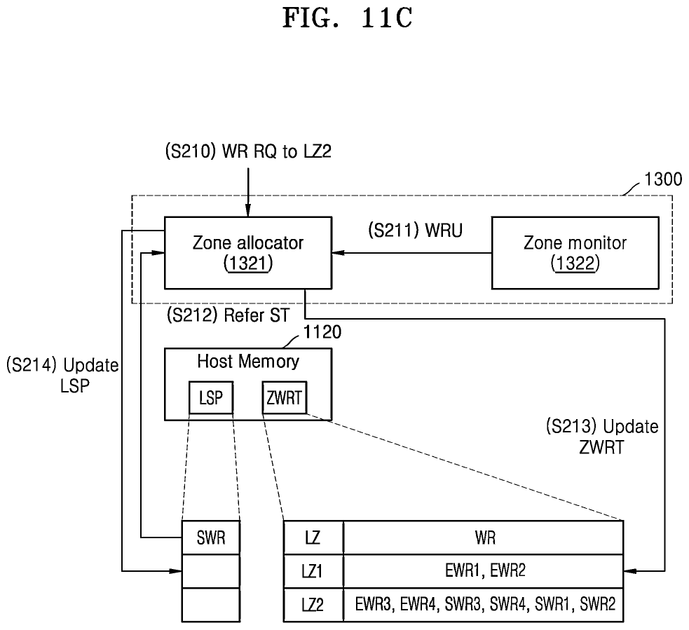

FIG. 10 is a diagram showing an example of a local overdrive operation according to one or more example embodiments. FIGS. 11A to 11C are diagrams showing examples of local overdrive operations according to one or more example embodiments.

Referring to FIGS. 1, 6, 10, and 11A to 11C, for example, the zone manager 1300 may allocate, to the first logical zone LZ1, a first essential write resource EWR1, a second essential write resource EWR2, a first spare write resource SWR1, and a second spare write resource SWR2. The zone manager 1300 may allocate, to the second logical zone LZ2, a third essential write resource EWR3, a fourth essential write resource EWR4, a third spare write resource SWR3, and a fourth spare write resource SWR4. The zone manager 1300 may reallocate the first spare write resource SWR1 and the second spare write resource SWR2 to the second logical zone LZ2.

The zone manager 1300 may perform a local overdrive operation. The local overdrive operation may represent an operation of renting spare write resources from another zone inside a namespace. Alternatively, the local overdrive operation may represent an operation of lending spare write resources to another zone inside a namespace. In other words, the local overdrive operation may represent an operation of reallocating spare write resources inside a namespace.

The zone manager 1300 may control the spare write resources inside the namespace. The zone manager 1300 may reallocate the spare write resources to a plurality of logical zones inside the namespace. The zone manager 1300 may redistribute the spare write resources to the plurality of logical zones inside the namespace based on a write resource utilization rate WRU. The zone manager 1300 may dynamically reallocate write resources.

The zone manager 1300 may reclaim spare write resources from a logical zone and then reallocate the reclaimed spare write resources to another logical zone in the same namespace. The zone manager 1300 may achieve a local overdrive operation by performing a stripe group open operation.

For example, the zone manager 1300 may reclaim the first spare write resource SWR1 and the second spare write resource SWR2 from the first logical zone LZ1. The zone manager 1300 may perform the stripe group open operation for a second stripe group SG2 of the first logical zone LZ1 and thus reclaim the first spare write resource SWR1 and the second spare write resource SWR2 based on the write resource utilization rate WRU. The zone manager 1300 may reallocate the first spare write resource SWR1 and the second spare write resource SWR2 to the second logical zone LZ2. The zone manager 1300 may perform the stripe group open operation for a fourth stripe group SG4 of the second logical zone LZ2 and thus reallocate the first spare write resource SWR1 and the second spare write resource SWR2 to the second logical zone LZ2 based on the write resource utilization rate WRU. That is, the zone manager 1300 may perform a local overdrive operation of reallocating the spare write resources within the first namespace NS1.

In the following descriptions, the first logical zone LZ1 is assumed to be in a state in which the first stripe group SG1 is not open yet, and the second logical zone LZ2 is assumed to be in a state in which the third stripe group SG3 is not open yet. In operation S201, the zone allocator 1321 may receive a write request for the first logical zone LZ1 from an application layer APP. The zone allocator 1321 may determine whether a stripe group of the first logical zone LZ1 is in an open state. Since the stripe group of the first logical zone LZ1 is not open, the zone allocator 1321 may perform a stripe group open operation on the stripe group. For example, the zone allocator 1321 may perform the stripe group open operation for the first stripe group SG1 of the first logical zone LZ1.

In operation S202, the zone monitor 1322 may transmit the write resource utilization rate WRU to the zone allocator 1321. The zone allocator 1321 may make a request for the write resource utilization rate WRU to the zone monitor 1322 so as to perform the stripe group open operation. The zone monitor 1322 may provide the write resource utilization rate WRU to the zone allocator 1321. The write resource utilization rate WRU may represent histories of active logical zones. The write resource utilization rate WRU may have information that is used to determine whether more spare write resources are required.

In operation S203, the zone allocator 1321 may refer to a local spare pool LSP. The local spare pool LSP may include the reclaimed spare write resources SWR. The local spare pool LSP may include the spare write resources used in the local overdrive operation. The zone allocator 1321 may determine the number of spare write resources of the first stripe group SG1 based on the write resource utilization rate WRU and the local spare pool LSP. For example, the zone allocator 1321 may determine not to change the number of spare write resources of the first stripe group SG1 based on states of the write resource utilization rate WRU and local spare pool LSP. The zone allocator 1321 may determine the number of spare write resources of the first stripe group SG1 to be ‘2.’ Accordingly, the stripe width of the first stripe group SG1 may be ‘4.’

In operation S204, the zone allocator 1321 may update a zone write resource table ZWRT. The zone allocator 1321 may store and update write resource allocation information about each of a plurality of logical zones in the zone write resource table ZWRT. The write resource allocation information may include the information about essential write resources and the information about spare write resources. If there is no change in the spare write resource, the zone allocator 1321 may skip operation S204.

For example, regarding the first logical zone LZ1, the zone write resource table ZWRT may include the write resource allocation information including the first essential write resource EWR1, the second essential write resource EWR2, the first spare write resource SWR1, and the second spare write resource SWR2. Regarding the second logical zone LZ2, the zone write resource table ZWRT may include the write resource allocation information including the third essential write resource EWR3, the fourth essential write resource EWR4, the third spare write resource SWR3, and the fourth spare write resource SWR4.

The zone manager 1300 may allocate physical zones PZ11 to PZ14 to the first stripe group SG1 based on the first essential write resource EWR1, the second essential write resource EWR2, the first spare write resource SWR1, and the second spare write resource SWR2. The physical zone PZ11 may correspond to the first essential write resource EWR1, the physical zone PZ12 may correspond to the second essential write resource EWR2, the physical zone PZ13 may correspond to the first spare write resource SWR1, and the physical zone PZ14 may correspond to the second spare write resource SWR2. The zone manager 1300 may write data to the first stripe group SG1.

Based on receiving the write request for the second logical zone LZ2, the zone manager 1300 may perform an open operation for the third stripe group SG3 of the second logical zone LZ2. The zone manager 1300 may allocate physical zones PZ21 to PZ24 based on the third essential write resource EWR3, the fourth essential write resource EWR4, the third spare write resource SWR3, and the fourth spare write resource SWR4. The physical zone PZ21 may correspond to the third essential write resource EWR3, the physical zone PZ22 may correspond to the fourth essential write resource EWR4, the physical zone PZ23 may correspond to the third spare write resource SWR3, and the physical zone PZ24 may correspond to the fourth spare write resource SWR4. The zone manager 1300 may store data of the second logical zone LZ2 in the third stripe group SG3.

The zone manager 1300 may perform the write operation until the write pointer WP reaches the end of the first stripe group SG1. When the write pointer WP reaches the end of the first stripe group SG1, the zone manager 1300 may perform the stripe group close operation for the first stripe group SG1. The zone manager 1300 may change the first stripe group SG1 to a closed state.

In operation S205, the zone allocator 1321 may receive a write request for the first logical zone LZ1 from the application layer APP. The zone allocator 1321 may determine whether a stripe group of the first logical zone LZ1 is in an open state. Since the stripe group of the first logical zone LZ1 is not open, the zone allocator 1321 may perform a stripe group open operation with respect to the stripe group of the first logical zone LZ1. The zone allocator 1321 may perform the stripe group open operation for the second stripe group SG2 of the first logical zone LZ1.

In operation S206, the zone monitor 1322 may transmit the write resource utilization rate WRU to the zone allocator 1321. In an embodiment, the write resource utilization rate WRU may indicate that less write resources of the first logical zone LZ1 are required. In operation S207, the zone allocator 1321 may refer to a local spare pool LSP. The zone allocator 1321 may determine the number of spare write resources of the second stripe group SG2 based on the write resource utilization rate WRU and the local spare pool LSP. The write resource utilization rate WRU may indicate a state in which less write resources of the first logical zone LZ1 are required, and there are no spare write resources in the local spare pool LSP. Therefore, the zone allocator 1321 may determine to reclaim spare write resources of the first logical zone LZ1. The zone allocator 1321 may determine to reclaim spare write resources of the first logical zone LZ1 based on the number of spare write resources of the second stripe group SG2. The zone allocator 1321 may reclaim the first spare write resource SWR1 and the second spare write resource SWR2 from the first logical zone LZ1.

In operation S208, the zone allocator 1321 may update a zone write resource table ZWRT. Regarding the first logical zone LZ1, the zone allocator 1321 may store write resource allocation information including the first essential write resource EWR1 and the second essential write resource EWR2 in the zone write resource table ZWRT. That is, regarding the first logical zone LZ1, the zone write resource table ZWRT may include the write resource allocation information including the first essential write resource EWR1 and the second essential write resource EWR2. Regarding the second logical zone LZ2, the zone write resource table ZWRT may include the write resource allocation information including the third essential write resource EWR3, the fourth essential write resource EWR4, the third spare write resource SWR3, and the fourth spare write resource SWR4.

In operation S209, the zone allocator 1321 may update the local spare pool LSP. The zone allocator 1321 may add the first spare write resource SWR1 and the second spare write resource SWR2 to the local spare pool LSP. The local spare pool LSP may include the first spare write resource SWR1 and the second spare write resource SWR2. The zone allocator 1321 may update the local spare pool LSP such that the local spare pool LSP includes the first spare write resource SWR1 and the second spare write resource SWR2.

The zone manager 1300 may allocate a physical zone PZ15 and a physical zone PZ16 to the second stripe group SG2. The physical zone PZ15 may correspond to the first essential write resource EWR1 and the physical zone PZ16 may correspond to the second essential write resource EWR2. The zone manager 1300 may store data of the first logical zone LZ1 in the second stripe group SG2 until the write pointer WP reaches the end of the second stripe group SG2.

When the write pointer WP reaches the end of the second stripe group SG2, the zone manager 1300 may perform the stripe group close operation for the second stripe group SG2. The zone manager 1300 may change the second stripe group SG2 to a closed state.

In operation S210, the zone allocator 1321 may receive a write request for the second logical zone LZ2 from the application layer APP. The zone allocator 1321 may determine whether a stripe group of the second logical zone LZ2 is in an open state. Since the stripe group of the second logical zone LZ2 is not open, the zone allocator 1321 may perform a stripe group open operation for the stripe group of the second logical zone LZ2. The zone allocator 1321 may perform the stripe group open operation for the fourth stripe group SG4 of the second logical zone LZ2.

In operation S211, the zone monitor 1322 may transmit the write resource utilization rate WRU to the zone allocator 1321. The write resource utilization rate WRU may indicate that more write resources of the second logical zone LZ2 are required. In operation S212, the zone allocator 1321 may refer to the local spare pool LSP. The zone allocator 1321 may determine the number of spare write resources of the fourth stripe group SG4 based on the write resource utilization rate WRU and the local spare pool LSP. The write resource utilization rate WRU may indicate a state in which more write resources of the second logical zone LZ2 are required, and the local spare pool LSP includes the first spare write resource SWR1 and the second spare write resource SWR2. Therefore, the zone allocator 1321 may determine to increase spare write resources of the second logical zone LZ2. The zone allocator 1321 may reallocate spare write resources of the second logical zone LZ2 based on the number of spare write resources of the fourth stripe group SG4. The zone allocator 1321 may reallocate the first spare write resource SWR1 and the second spare write resource SWR2 to the second logical zone LZ2. In other words, when the write resources of the second logical zone LZ2 are insufficient, the zone manager 1300 may rent the spare write resource of the first logical zone LZ1 and expand the stripe width of the fourth stripe group SG4.

In operation S213, the zone allocator 1321 may update the zone write resource table ZWRT. Regarding the second logical zone LZ2, the zone allocator 1321 may store, in the zone write resource table ZWRT, the write resource allocation information including the third essential write resource EWR3, the fourth essential write resource EWR4, the third spare write resource SWR3, the fourth spare write resource SWR4, the first spare write resource SWR1, and the second spare write resource SWR2.

That is, regarding the first logical zone LZ1, the zone write resource table ZWRT may include the write resource allocation information including the first essential write resource EWR1 and the second essential write resource EWR2. Regarding the second logical zone LZ2, the zone write resource table ZWRT may include the write resource allocation information including the third essential write resource EWR3, the fourth essential write resource EWR4, the third spare write resource SWR3, the fourth spare write resource SWR4, the first spare write resource SWR1, and the second spare write resource SWR2.

In operation S214, the zone allocator 1321 may update the local spare pool LSP. The zone allocator 1321 may remove the first spare write resource SWR1 and the second spare write resource SWR2 from the local spare pool LSP. The local spare pool LSP may be empty.

The zone manager 1300 may allocate physical zones PZ25, PZ26, PZ27, PZ28, PZ29, and PZ2A to the fourth stripe group SG4. The physical zone PZ25 may correspond to the third essential write resource EWR3, the physical zone PZ26 may correspond to the fourth essential write resource EWR4, the physical zone PZ27 may correspond to the third spare write resource SWR3, the physical zone PZ28 may correspond to the fourth spare write resource SWR4, the physical zone PZ29 may correspond to the first spare write resource SWR1, and the physical zone PZ2A may correspond to the second spare write resource SWR2. The zone manager 1300 may store data of the second logical zone LZ2 in the fourth stripe group SG4 until the write pointer WP reaches the end of the fourth stripe group SG4.

As described above, the zone manager 1300 may perform the local overdrive operation. The number of physical zones in the stripe group may be determined according to the local overdrive operation. The zone manager 1300 may perform the stripe group open operation. The zone manager 1300 may determine the number of spare write resources based on the write resource utilization rate WRU and the local resource pool. The zone manager 1300 may allocate, to the stripe group, physical zones corresponding to the sum of the number of essential write resources and the number of spare write resources. The zone manager 1300 may use resources efficiently and improve performance by dynamically allocating the write resources.

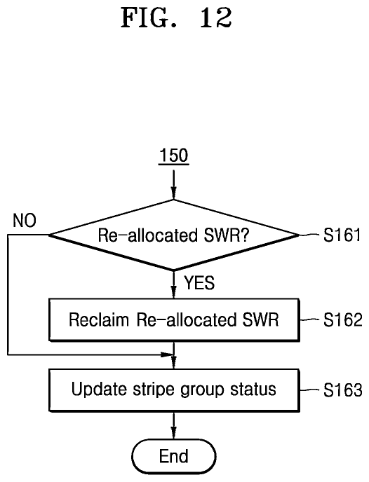

FIG. 12 is a flowchart showing operation S160 of FIG. 9 in more detail.

Referring to FIGS. 1, 9, and 12, the zone manager 1300 may perform the stripe group close operation. Operation S160 may include operations S161 to S163. In operation S161, the zone manager 1300 may determine whether there are reallocated spare write resources in the logical zone. That is, the zone manager 1300 may determine whether there are spare write resources rented from another logical zone. The zone manager 1300 may perform operation S162 if there are reallocated spare write resources and perform operation S163 if there are no reallocated spare write resources.

For example, the zone manager 1300 may perform the stripe group close operation for the fourth stripe group SG4 of the second logical zone LZ2. The zone manager 1300 may determine whether there are reallocated spare write resources in the second logical zone LZ2. That is, regarding the second logical zone LZ2, the zone manager 1300 may determine whether there are the first spare write resource SWR1 and the second spare write resource SWR2 rented from the first logical zone LZ1.

In operation S162, the zone manager 1300 may reclaim the reallocated spare write resources. For example, if the reallocated spare write resources exist in the second logical zone LZ2, the zone manager 1300 may reclaim, from the second logical zone LZ2, the first spare write resource SWR1 and the second spare write resource SWR2 which are reallocated spare write resources. The zone manager 1300 may add the first spare write resource SWR1 and the second spare write resource SWR2 to the local spare pool LSP.

In operation S163, the zone manager 1300 may update the stripe group status. The zone manager 1300 may change the status of the stripe group from open to closed. For example, the zone manager 1300 may update the status of the fourth stripe group SG4 from open to closed.

In an embodiment, when data is stored up to the end of the fourth stripe group SG4 of the second logical zone LZ2, the zone manager 1300 may reclaim the reallocated spare write resources. Alternatively, when receiving a FINISH command or a RESET command, the zone manager 1300 may reclaim the reallocated spare write resources. The zone manager 1300 may perform the stripe group close operation for the fourth stripe group SG4 in response to the FINISH command or the RESET command. The zone manager 1300 may reclaim the first spare write resource SWR1 and the second spare write resource SWR2 from the second logical zone LZ2.

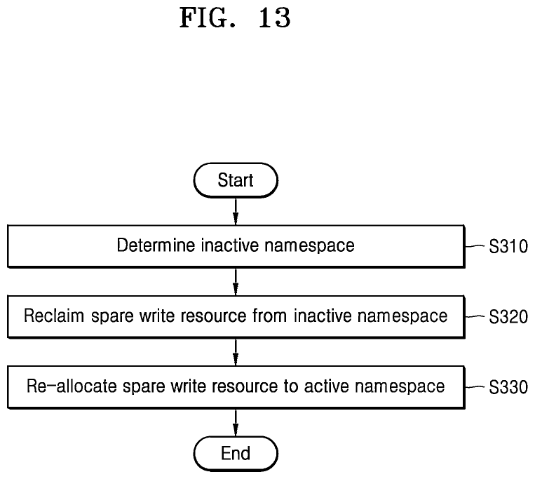

FIG. 13 is a diagram showing an example of a method of operating the zone manager 1300 of FIG. 1.

A first global overdrive operation is described with reference to FIG. 13. Referring to FIGS. 1, 7B, and 13, the zone manager 1300 may perform the global overdrive operation. The zone manager 1300 may adjust spare write resources for a plurality of namespaces. The zone manager 1300 may reallocate the spare write resources to the plurality of namespaces. The zone manager 1300 may redistribute the spare write resources to the plurality of namespaces. The zone manager 1300 may dynamically reallocate write resources. The zone manager 1300 may perform the global overdrive operation of reclaiming spare write resources of the second namespace NS2 and reallocating the spare write resources to the first namespace NS1.

The zone manager 1300 may perform the first global overdrive operation. The first global overdrive operation may represent an operation of reclaiming spare write resources from a namespace in an inactive state and allocating the spare write resources. A second global overdrive operation may represent an operation of reclaiming spare write resources from a namespace in a suspended state and allocating the spare write resources.

In operation S310, the zone manager 1300 may determine an inactive namespace. The zone manager 1300 may determine the namespace in the inactive state. When a write request for a namespace has not been received for a predetermined period of time without performing a stripe group open operation, the zone manager 1300 may determine that the namespace is in the inactive state. The inactive state may represent a state in which data has never been written. The inactive state may represent a state in which the stripe group is not opened and the physical zones are not allocated thereto. For example, the zone manager 1300 may determine the second namespace NS2 in an inactive state.

In operation S320, the zone manager 1300 may reclaim spare write resources from the inactive namespace. For example, the zone manager 1300 may reclaim the fifth spare write resource SWR5 and the sixth spare write resource SWR6 from the second namespace NS2. The zone manager 1300 may add the fifth spare write resource SWR5 and the sixth spare write resource SWR6 to a global spare pool GSP. The global spare pool GSP may include spare write resources SWR reclaimed during the global overdrive operation. The global spare pool GSP may include the spare write resources used in the global overdrive operation.

In operation S330, the zone manager 1300 may reallocate spare write resources to an active namespace. For example, the zone manager 1300 may reallocate the fifth spare write resource SWR5 and the sixth spare write resource SWR6 to the first namespace NS1.

In an embodiment, the zone manager 1300 may evenly distribute spare write resources of the global spare pool GSP to a plurality of namespaces. The zone manager 1300 may distribute the spare write resources to the namespaces in an active state based on the write resource utilization rate.

As described above, the zone manager 1300 may determine that the second namespace is in the inactive state. The zone manager 1300 may reclaim the fifth spare write resource SWR5 and the sixth spare write resource SWR6 from the second namespace NS2 and add the fifth spare write resource SWR5 and the sixth spare write resource SWR6 to the global spare pool GSP. The zone manager 1300 may perform the first global overdrive operation by reallocating the fifth spare write resource SWR5 and the sixth spare write resource SWR6 to the first namespace NS1.

While data is actively being written to the first namespace NS1, data may not be written to the second namespace NS2 after opening the second logical zone LZ2. That is, the third logical zone LZ3 or the second namespace NS2 may be in the inactive state. The zone manager 1300 may identify the second namespace NS2 as an inactive namespace and lend spare write resources of the second namespace NS2 to the first namespace NS1. When receiving a write request (or a command) from the second namespace NS2 after reclaiming the spare write resources from the second namespace NS2, the zone manager 1300 may allocate physical zones to the stripe group based on the essential write resources. That is, the zone manager 1300 may guarantee the minimum bandwidth based on the essential write resources.

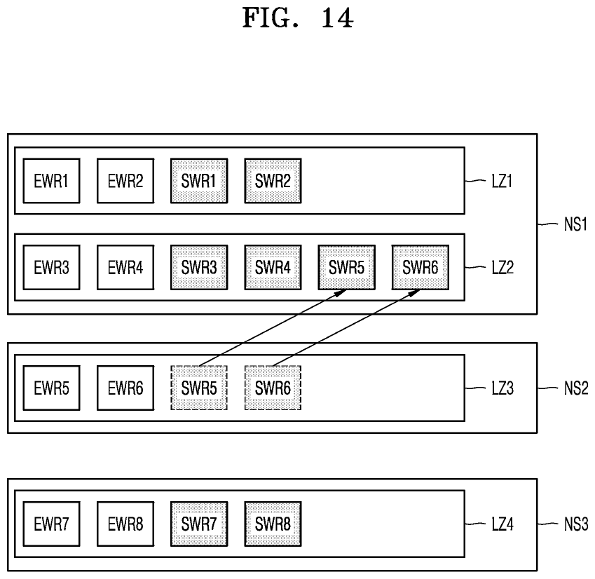

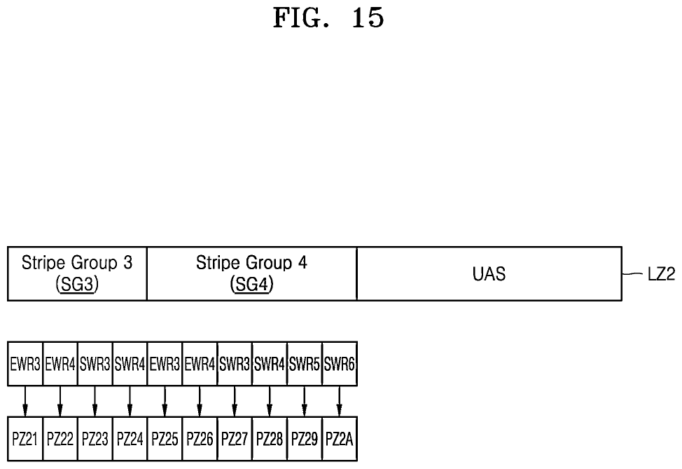

FIG. 14 is a diagram showing an example of a write resource allocation state by a first global overdrive operation according to one or more example embodiments. FIG. 15 is a diagram showing an example of a second logical zone LZ2 by the first global overdrive operation according to one or more example embodiments.

Referring to FIGS. 1, 14, and 15, the zone manager 1300 may perform the global overdrive operation. The zone manager 1300 may determine whether to perform the global overdrive operation based on write intensities for all namespaces (or all logical zones). The zone manager 1300 may perform monitoring operations and calculate a zone utilization rate. The zone manager 1300 may reclaim spare write resources from a namespace having a low zone utilization rate. The zone manager 1300 may evenly distribute the spare write resources to different namespaces. The zone manager 1300 may distribute spare write resources of an inactive namespace to other namespaces. That is, the zone manager 1300 may perform the first global overdrive operation. The zone manager 1300 may distribute spare write resources of a suspended namespace to other namespaces. That is, the zone manager 1300 may perform the second global overdrive operation.

Hereinafter, the first global overdrive operation is described. The zone manager 1300 may reclaim spare write resources from a namespace and reallocate the reclaimed spare write resources to another namespace. For example, the zone manager 1300 may determine that the second namespace NS2 is in an inactive state. The zone manager 1300 may reclaim spare write resources from the second namespace NS2 in the inactive state. The zone manager 1300 may reclaim the fifth spare write resource SWR5 and the sixth spare write resource SWR6 from the second namespace NS2. The zone manager 1300 may reallocate the fifth spare write resource SWR5 and the sixth spare write resource SWR6 to the first namespace NS1. The zone manager 1300 may perform the stripe group open operation for the fourth stripe group SG4 of the second logical zone LZ2 in the first namespace NS1 and thus reallocate the fifth spare write resource SWR5 and the sixth spare write resource SWR6 to the second logical zone LZ2.

In the following description, the second logical zone LZ2 is assumed to be in a state in which the third stripe group SG3 is not yet open. For example, the zone manager 1300 may receive a write request for the second logical zone LZ2 from the application layer APP. Since the stripe group of the second logical zone LZ2 is in a closed state, the zone manager 1300 may perform a stripe group open operation for the third stripe group SG3. The zone manager 1300 may allocate physical zones PZ21, PZ22, PZ23, and PZ24 to the third stripe group SG3, based on the third essential write resource EWR3, the fourth essential write resource EWR4, the third spare write resource SWR3, and the fourth spare write resource SWR4.

The physical zone PZ21 may correspond to the third essential write resource EWR3. The physical zone PZ22 may correspond to the fourth essential write resource EWR4. The physical zone PZ23 may correspond to the third spare write resource SWR3. The physical zone PZ24 may correspond to the fourth spare write resource SWR4.

Regarding the second logical zone LZ2, the zone manager 1300 may change the stripe group from a closed state to an open state. The zone manager 1300 may perform the write operation on the third stripe group SG3. When the write pointer WP reaches the end of the third stripe group SG3, the zone manager 1300 may perform the stripe group close operation for the third stripe group SG3. Regarding the second logical zone LZ2, the zone manager 1300 may change the stripe group from an open state to a closed state.

The zone manager 1300 may determine that the second namespace NS2 is in an inactive state. The zone manager 1300 may reclaim the fifth spare write resource SWR5 and the sixth spare write resource SWR6 from the second namespace NS2. The zone manager 1300 may add the fifth spare write resource SWR5 and the sixth spare write resource SWR6 to the global spare pool GSP.

The zone manager 1300 may receive a write request for the second logical zone LZ2 from the application layer APP. Since the stripe group of the second logical zone LZ2 is in a closed state, the zone manager 1300 may perform a stripe group open operation for the fourth stripe group SG4.

The zone manager 1300 may determine the number of spare write resources based on the write resource utilization rate WRU and the global spare pool GSP. The write resource utilization rate WRU may indicate a state in which more write resources of the second logical zone LZ2 are required, and the global spare pool GSP includes the fifth spare write resource SWR5 and the sixth spare write resource SWR6. Therefore, the zone manager 1300 may determine to increase spare write resources of the second logical zone LZ2. That is, the zone manager 1300 may determine the number of spare write resources in the second logical zone LZ2 to be ‘4.’ The zone manager 1300 may reallocate the fifth spare write resource SWR5 and the sixth spare write resource SWR6 of the global spare pool GSP to the second logical zone LZ2.

The zone manager 1300 may allocate physical zones PZ25, PZ26, PZ27, PZ28, PZ29, and PZ2A, based on the third essential write resource EWR3, the fourth essential write resource EWR4, the third spare write resource SWR3, the fourth spare write resource SWR4, the fifth spare write resource SWR5, and the sixth spare write resource SWR6. The physical zone PZ25 may correspond to the third essential write resource EWR3, the physical zone PZ26 may correspond to the fourth essential write resource EWR4, the physical zone PZ27 may correspond to the third spare write resource SWR3, the physical zone PZ28 may correspond to the fourth spare write resource SWR4, the physical zone PZ29 may correspond to the fifth spare write resource SWR5, and the physical zone PZ2A may correspond to the sixth spare write resource SWR6.

Regarding the second logical zone LZ2, the zone manager 1300 may change the stripe group from a closed state to an open state. The zone manager 1300 may perform the write operation on the fourth stripe group SG4.

When the write pointer WP reaches the end of the fourth stripe group SG4, the zone manager 1300 may perform the stripe group close operation for the fourth stripe group SG4. The zone manager 1300 may determine whether the spare write resources reallocated to the second logical zone LZ2 exist. When the reallocated spare write resources exist in the second logical zone LZ2, the zone manager 1300 may reclaim the reallocated spare write resources from the second logical zone LZ2.

The zone manager 1300 may determine that the fifth spare write resource SWR5 and the sixth spare write resource SWR6 rented from the second namespace NS2 exist in the second logical zone LZ2. The zone manager 1300 may reclaim the fifth spare write resource SWR5 and the sixth spare write resource SWR6 from the first namespace NS1. The zone manager 1300 may add the fifth spare write resource SWR5 and the sixth spare write resource SWR6 to the global spare pool GSP. Regarding the second logical zone LZ2, the zone manager 1300 may change the stripe group from an open state to a closed state.

As described above, when the write resources of the first namespace NS1 are insufficient, the zone manager 1300 may rent the spare write resource from the second namespace NS2 and expand the stripe width of the fourth stripe group SG4. The zone manager 1300 may reclaim the reallocated spare write resources while performing the stripe group close operation of the fourth stripe group SG4.

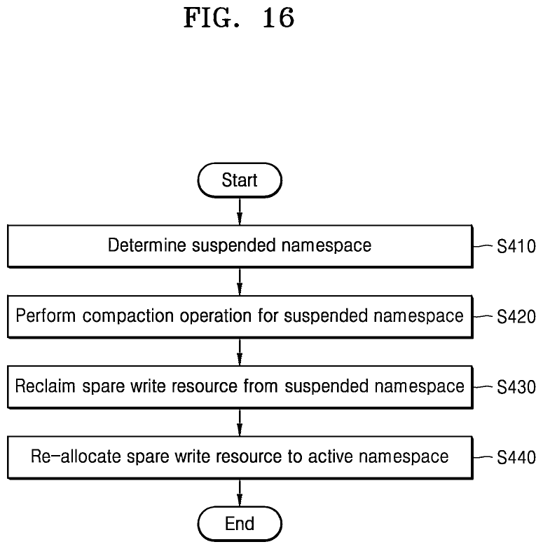

FIG. 16 is a diagram showing an example of a method of operating the zone manager 1300 of FIG. 1.

The second global overdrive operation is described with reference to FIG. 16. Referring to FIGS. 1, 7B, and 16, the zone manager 1300 may perform the second global overdrive operation. In operation S410, the zone manager 1300 may determine a suspended namespace. The zone manager 1300 may determine the namespace in the suspended state. For example, the suspended state may represent a frozen state. When a write request for a namespace for a predetermined period of time while performing a stripe group open operation, the zone manager 1300 may determine that the namespace is in the suspended state. The suspended state may represent a state in which physical zones have been allocated to the stripe group through the stripe group open operation and data has been written to the physical zones, but the last stripe of the stripe group has not been written. The suspended state may represent a state in which a stripe group is open but is not completed for a predetermined period of time. The suspended state may represent a state in which data has been written to only part of the stripe group. For example, the zone manager 1300 may determine the third namespace NS3 in an inactive state.

In operation S420, the zone manager 1300 may perform a compaction operation on the suspended namespace. The zone manager 1300 may perform the compaction operation similar to garbage collection. For example, the garbage collection represents a technology for securing usable capacity within the non-volatile memory device 1220 by copying valid data of an existing block to a new block and then erasing the existing block. The zone manager 1300 may perform the compaction operation so as to reclaim the spare write resources of the suspended namespace. The compaction operation may represent an operation of reading data stored in a previous stripe group and writing the read data to a new stripe group. Also, the compaction operation may represent an operation of reclaiming the write resources after copying valid data from the previous stripe group to the new stripe group.

Also, the stripe width of the previous stripe group may be greater than the stripe width of the new stripe group. For example, data in the fifth stripe group SG5 may be read and then the read data may be stored in the sixth stripe group SG6.

In operation S430, the zone manager 1300 may reclaim spare write resources from the suspended namespace. For example, the zone manager 1300 may reclaim the seventh spare write resource SWR7 and the eighth spare write resource SWR8 from the third namespace NS3. The zone manager 1300 may add the seventh spare write resource SWR7 and the eighth spare write resource SWR8 to the global spare pool GSP.

In operation S440, the zone manager 1300 may reallocate spare write resources to an active namespace. For example, the zone manager 1300 may reallocate the seventh spare write resource SWR7 and the eighth spare write resource SWR8 to the first namespace NS1.

As described above, if there is no write request for a stripe group of the third namespace NS3 for a critical (or predetermined) period of time after performing the stripe group open operation, the zone manager 1300 may determine that the third namespace NS3 is in a suspended state. The zone manager 1300 may perform the compaction operation on the third namespace NS3. The zone manager 1300 may reclaim the seventh spare write resource SWR7 and the eighth spare write resource SWR8 from the third namespace NS3 and add the seventh spare write resource SWR7 and the eighth spare write resource SWR8 to the global spare pool GSP. The zone manager 1300 may perform an overdrive operation by reallocating the seventh spare write resource SWR7 and the eighth spare write resource SWR8 to the first namespace NS1.

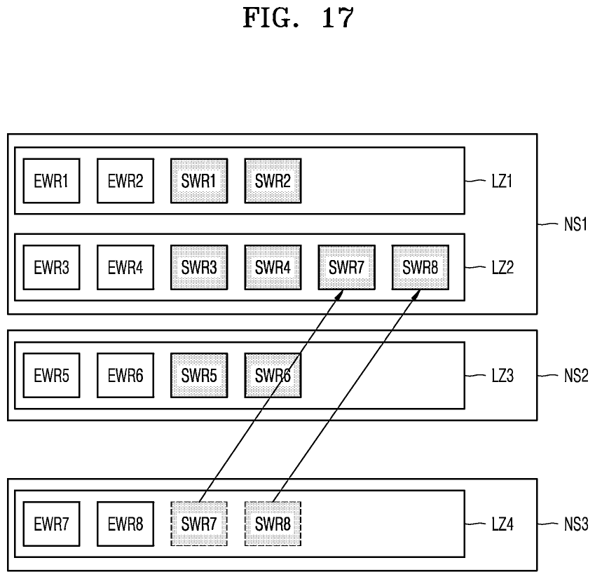

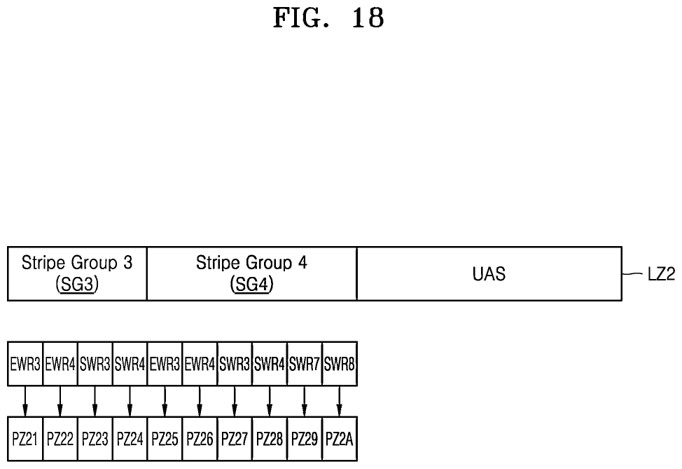

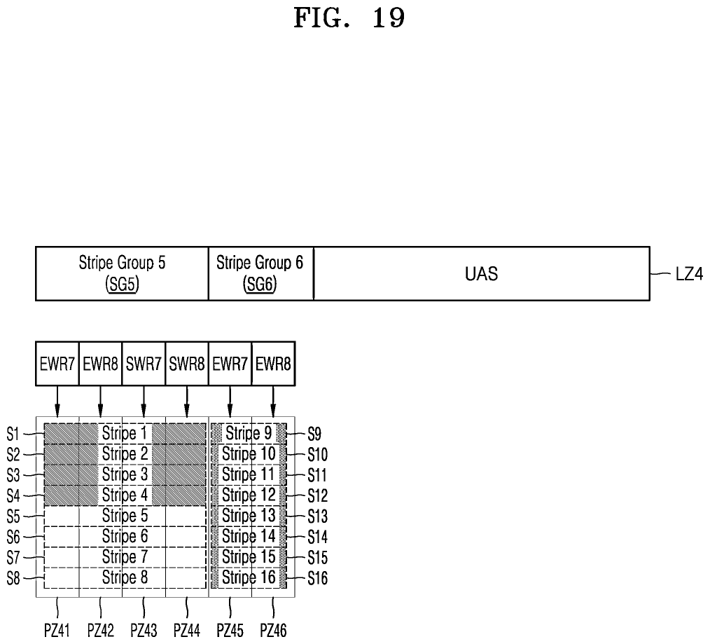

FIG. 17 is a diagram showing an example of a write resource allocation state in a second global overdrive operation according to one or more example embodiments. FIG. 18 is a diagram showing an example of a second logical zone LZ2 in the second global overdrive operation according to one or more example embodiments. FIG. 19 is a diagram showing an example of a fourth logical zone LZ4 in the second global overdrive operation according to one or more example embodiments.

Referring to FIGS. 1, 17, 18, and 19, the zone manager 1300 may perform the second global overdrive operation. The zone manager 1300 may reclaim spare write resources from a namespace and reallocate the reclaimed spare write resources to another namespace. For example, the zone manager 1300 may determine that the third namespace NS3 is in a suspended state. The zone manager 1300 may reclaim spare write resources from the third namespace NS3 in the suspended state. The zone manager 1300 may reclaim the seventh spare write resource SWR7 and the eighth spare write resource SWR8 from the third namespace NS3. The zone manager 1300 may reallocate the seventh spare write resource SWR7 and the eighth spare write resource SWR8 to the first namespace NS1. The zone manager 1300 may perform the stripe group open operation for the fourth stripe group SG4 of the second logical zone LZ2 in the first namespace NS1 and thus reallocate the seventh spare write resource SWR7 and the eighth spare write resource SWR8 to the second logical zone LZ2.

In the following descriptions, the second logical zone LZ2 of the first namespace NS1 is assumed to be in a state in which the third stripe group SG3 is not yet open and the fourth logical zone LZ4 of the third namespace NS3 is assumed to be in a state in which the fifth stripe group SG5 is not yet open.

For example, the zone manager 1300 may receive a write request for the second logical zone LZ2 from the application layer APP. Since the stripe group of the second logical zone LZ2 is in a closed state, the zone manager 1300 may perform a stripe group open operation for the third stripe group SG3. The zone manager 1300 may allocate physical zones PZ21, PZ22, PZ23, and PZ24 to the third stripe group SG3, based on the third essential write resource EWR3, the fourth essential write resource EWR4, the third spare write resource SWR3, and the fourth spare write resource SWR4.

The physical zone PZ21 may correspond to the third essential write resource EWR3. The physical zone PZ22 may correspond to the fourth essential write resource EWR4. The physical zone PZ23 may correspond to the third spare write resource SWR3. The physical zone PZ24 may correspond to the fourth spare write resource SWR4.

Regarding the second logical zone LZ2, the zone manager 1300 may change the stripe group from a closed state to an open state. The zone manager 1300 may perform the write operation on the third stripe group SG3.

The zone manager 1300 may receive a write request for the fourth logical zone LZ4 from the application layer APP. Since the stripe group of the fourth logical zone LZ4 is in a closed state, the zone manager 1300 may perform a stripe group open operation for the fifth stripe group SG5. The zone manager 1300 may allocate physical zones PZ41, PZ42, PZA3, and PZ44 to the fifth stripe group SG5, based on the seventh essential write resource EWR7, the eighth essential write resource EWR8, the seventh spare write resource SWR7, and the eighth spare write resource SWR8.

The physical zone PZ41 may correspond to the seventh essential write resource EWR7. The physical zone PZ42 may correspond to the eighth essential write resource EWR8. The physical zone PZ43 may correspond to the seventh spare write resource SWR7. The physical zone PZA4 may correspond to the eighth spare write resource SWR8.

Regarding the fourth logical zone LZ4, the zone manager 1300 may change the stripe group from a closed state to an open state. The zone manager 1300 may perform the write operation on the fifth stripe group SG5. The zone manager 1300 may store data in the first to fourth stripes S1 to S4. The write pointer WP may point to the fifth stripe S5. Since then, there may be no write request for the fourth logical zone LZ4. The zone manager 1300 may determine that there has been no write request for the fourth logical zone LZ4 for a predetermined period of time. The zone manager 1300 may determine that the third namespace NS3 is in a suspended state.

The zone manager 1300 may perform the compaction operation on the third namespace NS3. The zone manager 1300 may perform the compaction operation so as to reclaim the spare write resources allocated to the third namespace NS3. The zone manager 1300 may read valid data stored in the fifth stripe group SG5. That is, the zone manager 1300 may read the valid data stored in the first to fourth stripes S1 to S4 of the fifth stripe group SG5. For example, the zone manager 1300 may store the valid data in the host memory 1120. The zone manager 1300 may perform the stripe group close operation for the fifth stripe group SG5. The zone manager 1300 may perform the stripe group open operation for the sixth stripe group SG6.

The zone manager 1300 may determine the number of spare write resources. The write resource utilization rate WRU of the third namespace NS3 may indicate a state in which less write resources are required, and thus, the zone manager 1300 may determine to reduce the spare write resources. The zone manager 1300 may determine the number of spare write resources in the fourth logical zone LZ4 to be ‘0.’ The zone manager 1300 may determine the stripe width of the sixth stripe group SG6 to be ‘2.’ The zone manager 1300 may allocate the physical zones PZ45 and PZ46 to the sixth stripe group SG6, based on the seventh essential write resource EWR7 and the eighth essential write resource EWR8. The physical zone PZ45 may correspond to the seventh essential write resource EWR7. The physical zone PZ46 may correspond to the eighth essential write resource EWR8. The zone manager 1300 may store, in the sixth stripe group SG6, the valid data read from the fifth stripe group SG5. The zone manager 1300 may store the valid data in the ninth to sixteenth stripes S9 to S16 of the sixth stripe group SG6.

The zone manager 1300 may reclaim the spare write resources of the third namespace NS3. The zone manager 1300 may reclaim the seventh spare write resource SWR7 and the eighth spare write resource SWR8 from the fourth logical zone LZ4. The zone manager 1300 may add the seventh spare write resource SWR7 and the eighth spare write resource SWR8 to the global spare pool GSP.

When the write pointer WP reaches the end of the third stripe group SG3, the zone manager 1300 may perform the stripe group close operation for the third stripe group SG3. Regarding the second logical zone LZ2, the zone manager 1300 may change the stripe group from an open state to a closed state.

The zone manager 1300 may receive a write request for the second logical zone LZ2 from the application layer APP. Since the stripe group of the second logical zone LZ2 is in a closed state, the zone manager 1300 may perform a stripe group open operation for the fourth stripe group SG4.

The zone manager 1300 may determine the number of spare write resources based on the write resource utilization rate WRU and the global spare pool GSP. The write resource utilization rate WRU may indicate a state in which more write resources of the second logical zone LZ2 are required, and the global spare pool GSP includes the seventh spare write resource SWR7 and the eighth spare write resource SWR8. Therefore, the zone manager 1300 may determine to increase spare write resources of the second logical zone LZ2. That is, the zone manager 1300 may determine the number of spare write resources in the second logical zone LZ2 to be ‘4.’ The zone manager 1300 may reallocate the seventh spare write resource SWR7 and the eighth spare write resource SWR8 of the global spare pool GSP to the second logical zone LZ2.

The zone manager 1300 may allocate physical zones PZ25, PZ26, PZ27, PZ28, PZ29, and PZ2A, based on the third essential write resource EWR3, the fourth essential write resource EWR4, the third spare write resource SWR3, the fourth spare write resource SWR4, the seventh spare write resource SWR7, and the eighth spare write resource SWR8. The physical zone PZ25 may correspond to the third essential write resource EWR3. The physical zone PZ26 may correspond to the fourth essential write resource EWR4. The physical zone PZ27 may correspond to the third spare write resource SWR3. The physical zone PZ28 may correspond to the fourth spare write resource SWR4. The physical zone PZ29 may correspond to the seventh spare write resource SWR7. The physical zone PZ2A may correspond to the eighth spare write resource SWR8. Regarding the second logical zone LZ2, the zone manager 1300 may change the stripe group from a closed state to an open state. The zone manager 1300 may perform the write operation on the fourth stripe group SG4.

When the write pointer WP reaches the end of the fourth stripe group SG4, the zone manager 1300 may perform the stripe group close operation for the fourth stripe group SG4. The zone manager 1300 may determine whether there are reallocated spare write resources in the second logical zone LZ2. The zone manager 1300 may determine that the seventh spare write resource SWR7 and the eighth spare write resource SWR8 rented from the third namespace NS3 exist in the second logical zone LZ2. The zone manager 1300 may reclaim the seventh spare write resource SWR7 and the eighth spare write resource SWR8 from the first namespace NS1. The zone manager 1300 may add the seventh spare write resource SWR7 and the eighth spare write resource SWR8 to the global spare pool GSP. Regarding the second logical zone LZ2, the zone manager 1300 may change the stripe group from an open state to a closed state.

As described above, the zone manager 1300 may perform the compaction operation on the suspended namespace. The zone manager 1300 may allocate the physical zone PZ45 and the physical zone PZ46 to the sixth stripe group SG6 of the fourth logical zone LZ4. The zone manager 1300 may read first data stored in the fifth stripe group SG5. The zone manager 1300 may write the first data to the sixth stripe group SG6. The zone manager 1300 may reclaim the spare write resources through the compaction operation. The zone manager 1300 may perform the second global overdrive operation and reclaim the spare write resources allocated to the namespace in the suspended state. The zone manager 1300 may reallocate the reclaimed spare write resources to the active namespace. The zone manager 1300 may use the write resources efficiently.

FIG. 20 is a block diagram showing the read scheduler 1311 of FIG. 3 in more detail.

Referring to FIGS. 1, 3, and 20, the read scheduler 1311 may include first to fourth read queues RQ1 to RQ4, a read queue monitor RQM, and a read congestion control manager RCM.

The read scheduler 1311 may measure the read latency for each logical zone. The read scheduler 1311 may determine, based on the read latency, whether a logical zone is congested. If the read latency is greater than a threshold, the read scheduler 1311 may determine that the logical zone is congested. For example, the read latency may represent a waiting time for execution of I/O commands.

The read scheduler 1311 may include a read queue for each of the logical zones. For example, the first read queue RQ1 may correspond to a first logical zone LZ1, the second read queue RQ2 may correspond to a second logical zone LZ2, the third read queue RQ3 may correspond to a third logical zone LZ3, and the fourth read queue RQ4 may correspond to a fourth logical zone LZ4. However, the scope of the disclosure is not limited thereto, and the number of read queues may increase or decrease according to embodiments.

The read scheduler 1311 may queue a read request for the first logical zone LZ1 in the first read queue RQ1. The read scheduler 1311 may queue a read request for the second logical zone LZ2 in the second read queue RQ2. The read scheduler 1311 may queue a read request for the third logical zone LZ3 in the third read queue RQ3. The read scheduler 1311 may queue a read request for the fourth logical zone LZA in the fourth read queue RQ4. Also, applications may queue read commands or read requests in corresponding read queues.

The read queue monitor RQM may monitor the read latency. The read queue monitor RQM may monitor the read latency of each logical zone. The read queue monitor RQM may include first to fourth monitors M1 to M4. The first monitor M1 may correspond to the first read queue RQ1, the second monitor M2 may correspond to the second read queue RQ2, the third monitor M3 may correspond to the third read queue RQ3, and the fourth monitor M4 may correspond to the fourth read queue RQ4.

The first monitor M1 may measure and monitor the read latency of the first logical zone LZ1. The second monitor M2 may measure and monitor the read latency of the second logical zone LZ2. The third monitor M3 may measure and monitor the read latency of the third logical zone LZ3. The fourth monitor M4 may measure and monitor the read latency of the fourth logical zone LZ4.

The read congestion control manager RCM may perform a delay-based congestion control operation. The read congestion control manager RCM may use a congestion control mechanism to determine bandwidth allocation for the stripe group.

The read congestion control manager RCM may include first to fourth congestion control units CC1 to CC4. The first congestion control unit CC1 may correspond to the first logical zone LZ1, the second congestion control unit CC2 may correspond to the second logical zone LZ2, the third congestion control unit CC3 may correspond to the third logical zone LZ3, and the fourth congestion control unit CC4 may correspond to the fourth logical zone LZ4.

Each of the first to fourth congestion control units CC1 to CC4 may perform a congestion control operation of the corresponding logical zone. Each of the first to fourth congestion control units CC1 to CC4 may receive the read latency from the corresponding monitor. When the read latency is greater than the threshold, each of the first to fourth congestion control units CC1 to CC4 may determine that the corresponding logical zone is congested. Each of the first to fourth congestion control units CC1 to CC4 may perform a congestion control operation for a congested logical zone. Each of the first to fourth congestion control units CC1 to CC4 may reduce the queue depth of the corresponding read queue (that is, the maximum number of commands or requests that may be stored in the read queue) when the corresponding logical zone is determined to be congested.

For example, the first monitor M1 may provide the read latency of the first logical zone LZ1 to the first congestion control unit CC1. The first congestion control unit CC1 may receive the read latency. The first congestion control unit CC1 may compare the read latency to a threshold. The first congestion control unit CC1 may determine that the read latency is greater than the threshold. When determining that the read latency is greater than the threshold, the first congestion control unit CC1 may perform the congestion control operation. The first congestion control unit CC1 may reduce the queue depth of the first read queue RQ1.

As described above, the zone manager 1300 may monitor the read latency for each of the first to fourth logical zones LZ1 to LZ4. The zone manager 1300 may determine whether the read latency of each of the first to fourth logical zones LZ1 to LZA exceeds a threshold. When the read latency exceeds the threshold, the zone manager 1300 may perform the congestion control operation on the logical zone corresponding to the read latency exceeding the threshold.

FIG. 21 is a block diagram showing the write scheduler 1312 of FIG. 3 in more detail.

Referring to FIGS. 1, 3, and 21, the write scheduler 1312 may include first to fourth write queues WQ1 to WQ4, a write queue monitor WQM, and a token generator TG. The write scheduler 1312 may monitor global write latency and use a token-based admission control method. The write scheduler 1312 may adjust a token generation rate based on the normalized write latency.

The write scheduler 1312 may measure write latency. For example, the write latency may represent a waiting time for execution of I/O commands. The write scheduler 1312 may measure the average write latency for all logical zones. The write scheduler 1312 may generate tokens at each time corresponding to the average write latency. That is, the write scheduler 1312 may periodically generate write tokens for a plurality of logical zones at each time corresponding to the average write latency.

The write scheduler 1312 may include a write queue for each of the logical zones. For example, the first write queue WQ1 may correspond to the first logical zone LZ1, the second write queue WQ2 may correspond to the second logical zone LZ2, the third write queue WQ3 may correspond to the third logical zone LZ3, and the fourth write queue WQ4 may correspond to the fourth logical zone LZ4. However, the scope of the disclosure is not limited thereto, and the number of write queues may increase or decrease according to embodiments.

The write scheduler 1312 may queue a write request for the first logical zone LZ1 in the first write queue WQ1. The write scheduler 1312 may queue a write request for the second logical zone LZ2 in the second write queue WQ2. The write scheduler 1312 may queue a write request for the third logical zone LZ3 in the third write queue WQ3. The write scheduler 1312 may queue a write request for the fourth logical zone LZA in the fourth write queue WQ4. Also, applications may queue write requests or write commands in corresponding write queues.

The write queue monitor WQM may monitor the write latency. The write queue monitor WQM may monitor the average write latency for a plurality of logical zones. The write queue monitor WQM may measure write latency for the first to fourth logical zones LZ1 to LZ4 and calculate the average latency.

The token generator TG may periodically generate tokens. The token generator TG may generate the tokens at each time based on the average write latency. A token generation cycle may be equal to the average write latency. The token generator TG may adjust the token generation rate based on the average write latency.

As described above, the zone manager 1300 may monitor the average write latency for the first to fourth logical zones LZ1 to LZ4. The zone manager 1300 may periodically generate write tokens in each of the first to fourth logical zones LZ1 to LZ4 at each time corresponding to the average write latency.

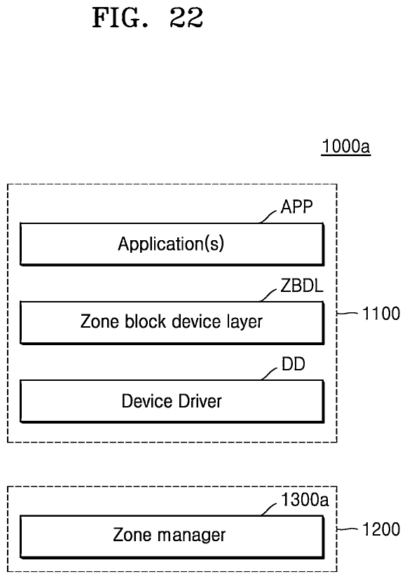

FIG. 22 is a diagram showing an example of software layers of the storage system 1000 of FIG. 1.

Referring to FIGS. 1 and 22, the software layers of a storage system 1000a may include an application layer APP, a zone block device layer ZBDL, a device driver layer DD, and a zone manager 1300a. A host device 1100 may include the application layer APP, the zone block device layer ZBDL, and the device driver layer DD. A storage device 1200 may include the zone manager 1300a. For convenience of description, detailed descriptions of the components described above are omitted.

Referring to FIG. 2, the host device 1100 may include the zone manager 1300.

Referring to FIG. 22, the storage device 1200 may include the zone manager 1300a similar to the zone manager 1300 described above with reference to FIGS. 1 to 21. Based on the methods described with reference to FIGS. 1 to 21, the zone manager 1300a may perform the local overdrive operation and the global overdrive operation. The zone manager 1300a may measure read latency for each of logical zones and perform congestion control operations individually for the logical zones based on the measurement results. Also, the zone manager 1300a may measure the average write latency for all logical zones and generate write tokens based on the measurement results.

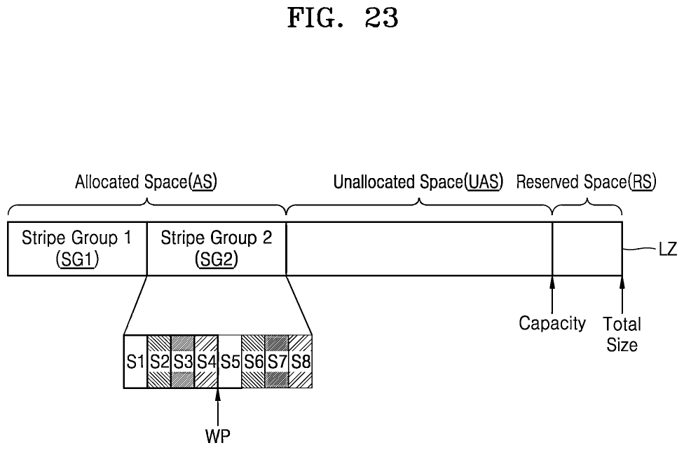

FIG. 23 is a diagram showing an example of a logical zone LZ according to one or more example embodiments.

Referring to FIGS. 1, 5, and 23, the logical zone LZ may include an allocated space AS, an unallocated space UAS, and a reserved space RS. The allocated space AS is the same as or similar to the allocated space AS of FIG. 5, and thus, detailed descriptions thereof are omitted for convenience of description. The unallocated space UAS is the same as or similar to the unallocated space UAS of FIG. 5, and thus, detailed descriptions thereof are omitted.

Logical addresses may be allocated to the allocated space AS and unallocated space UAS. The reserved space RS may include a space that is not provided to the application layer APP. For example, the reserved space RS may be used to improve performance. The reserved space RS may be used as replacement memory, backup memory, and buffering memory. The reserved space RS may be used for compaction operations. The reserved space RS may store metadata.

The capacity of the logical zone LZ may represent the amount of space that may be used (or accessed) by the application layer APP. The total size of the logical zone LZ may include all of the allocated space AS and unallocated space UAS that are accessible by the application layer APP and the reserved space RS that is inaccessible to the application layer APP.

At least one of the components, elements, modules and units (collectively “components” in this paragraph) represented by a block or an equivalent indication in the drawings including FIG. 1 described above may use a direct circuit structure, such as a memory, a processor, a logic circuit, a look-up table, etc. that may execute the respective functions through controls of one or more microprocessors or other control apparatuses. Alternatively or additionally, at least one of these components may be specifically embodied by a module, a program, or a part of code, which is stored in an internal memory of the host controller 1110, the host memory 1120, an internal memory of the storage controller 1210 or an external memory, and contains one or more executable instructions for performing the above-described functions, and executed by one or more microprocessors or other controller included in the host controller 1110 or the storage controller 1120. Further, at least one of these components may include or may be implemented by a processor such as a central processing unit (CPU), graphic processing unit (GPU), another type of microprocessor, or the like in the host controller 1110 or the storage controller 1120 that performs the above-described functions. Two or more of these components may be combined into one single component which performs all operations or functions of the combined two or more components. Also, at least part of functions of at least one of these components may be performed by another of these components. Functional aspects of the above example embodiments may be implemented in algorithms that execute on one or more processors.

While the disclosure has been particularly shown and described with reference to example embodiments thereof, it will be understood that various changes in form and details may be made therein without departing from the spirit and scope of the following claims and their equivalents.

1. A method of operating a storage system comprising a host device and a storage device, the host device comprising a zone manager, the method comprising:
allocating, by the zone manager, a first essential write resource, a second essential write resource, a first spare write resource, and a second spare write resource to a first logical zone;
allocating, by the zone manager, a third essential write resource, a fourth essential write resource, a third spare write resource, and a fourth spare write resource to a second logical zone; and
reallocating, by the zone manager, the first spare write resource and the second spare write resource to the second logical zone.

2. The method of claim 1, wherein the first logical zone comprises a first stripe group in a closed state and a second stripe group in an open state,
wherein the first stripe group comprises a first physical zone corresponding to the first essential write resource, a second physical zone corresponding to the second essential write resource, a third physical zone corresponding to the first spare write resource, and a fourth physical zone corresponding to the second spare write resource, and
wherein the second stripe group comprises a fifth physical zone corresponding to the first essential write resource and a sixth physical zone corresponding to the second essential write resource.

3. The method of claim 2, further comprising storing, by the storage device, a first portion of first data for the first logical zone in the fifth physical zone and storing a second portion of the first data for the first logical zone in the sixth physical zone.

4. The method of claim 1, wherein a first namespace comprises the first logical zone and the second logical zone,
wherein a second namespace comprises a third logical zone,
wherein a third namespace comprises a fourth logical zone, and
wherein the method further comprises:
allocating, by the zone manager, a fifth essential write resource, a sixth essential write resource, a fifth spare write resource, and a sixth spare write resource to the third logical zone; and
allocating, by the zone manager, a seventh essential write resource, an eighth essential write resource, a seventh spare write resource, and an eighth spare write resource to the fourth logical zone.

5. The method of claim 1, further comprising:
receiving, by the zone manager, a write request for the second logical zone;
performing, by the zone manager, a stripe group open operation of the second logical zone based on a stripe group of the second logical zone being not in an open state;
performing, by the zone manager, a write operation on the stripe group of the second logical zone that is in the open state;
determining, by the zone manager, whether the write operation has been performed on a last stripe in the stripe group of the second logical zone; and
performing, by the zone manager, a stripe group close operation based on determining that the write operation has been performed on the last stripe.

6. The method of claim 5, wherein the performing the stripe group open operation comprises:
determining, by the zone manager, a number of spare write resources of the stripe group of the second logical zone based on a write resource utilization rate and a local resource pool; and
allocating, by the zone manager, physical zones to the stripe group of the second logical zone, wherein a number of the physical zones correspond to a sum of a number of essential write resources of the stripe group of the second logical zone and the number of spare write resources of the stripe group of the second logical zone.

7. The method of claim 1, wherein a first namespace comprises the first logical zone and the second logical zone, and
wherein the reallocating comprises performing, by the zone manager, a local overdrive operation of reallocating spare write resources in the first namespace.

8. The method of claim 1, further comprising:
performing, by the zone manager, a stripe group open operation for a first stripe group of the first logical zone;
performing, by the zone manager, a stripe group open operation for a third stripe group of the second logical zone;
performing, by the zone manager, a stripe group close operation for the first stripe group of the first logical zone;
performing, by the zone manager, a stripe group open operation for a second stripe group of the first logical zone;
performing, by the zone manager, a stripe group close operation for the third stripe group of the second logical zone;
performing, by the zone manager, a stripe group open operation for a fourth stripe group of the second logical zone; and
performing, by the zone manager, a stripe group close operation for the fourth stripe group of the second logical zone.

9. The method of claim 8, wherein the performing the stripe group open operation for the first stripe group comprises allocating, by the zone manager, a first physical zone, a second physical zone, a third physical zone, and a fourth physical zone to the first stripe group, and
wherein the performing the stripe group open operation for the third stripe group comprises allocating, by the zone manager, a fifth physical zone, a sixth physical zone, a seventh physical zone, and an eighth physical zone to the third stripe group, and
wherein the first physical zone corresponds to the first essential write resource, the second physical zone corresponds to the second essential write resource, the third physical zone corresponds to the first spare write resource, the fourth physical zone corresponds to the second spare write resource, the fifth physical zone corresponds to the third essential write resource, the sixth physical zone corresponds to the fourth essential write resource, the seventh physical zone corresponds to the third spare write resource, and the eighth physical zone corresponds to the fourth spare write resource.

10. The method of claim 8, wherein the performing the stripe group open operation for the second stripe group of the first logical zone comprises:
determining, by the zone manager, a number of spare write resources of the second stripe group based on a write resource utilization rate and a local spare pool of the first logical zone;
based on the determined number of spare write resources of the second stripe group, reclaiming, by the zone manager, the first spare write resource and the second spare write resource from the first logical zone and updating the local spare pool to include the first spare write resource and the second spare write resource; and
allocating, by the zone manager, a ninth physical zone and a tenth physical zone to the second stripe group, and
wherein the ninth physical zone corresponds to the first essential write resource, and the tenth physical zone corresponds to the second essential write resource.

11. The method of claim 8, wherein the performing the stripe group open operation for the fourth stripe group of the second logical zone comprises:
determining, by the zone manager, a number of spare write resources of the fourth stripe group based on a write resource utilization rate and a local spare pool of the second logical zone;
based on the determined number of spare write resources of the fourth stripe group, reallocating, by the zone manager, the first spare write resource and the second spare write resource to the second logical zone; and
allocating, by the zone manager, an eleventh physical zone, a twelfth physical zone, a thirteenth physical zone, a fourteenth physical zone, a fifteenth physical zone, and a sixteenth physical zone to the fourth stripe group, and
wherein the eleventh physical zone corresponds to the third essential write resource, the twelfth physical zone corresponds to the fourth essential write resource, the thirteenth physical zone corresponds to the third spare write resource, the fourteenth physical zone corresponds to the fourth spare write resource, the fifteenth physical zone corresponds to the first spare write resource, and the sixteenth physical zone corresponds to the second spare write resource.

12. The method of claim 8, wherein the performing the stripe group close operation for the fourth stripe group comprises:
determining, by the zone manager, whether a reallocated spare write resource exists in the second logical zone; and
reclaiming, by the zone manager, the first spare write resource and the second spare write resource from the second logical zone based on a determination that the reallocated spare write resource exists in the second logical zone, wherein each of the first spare write resource and the second spare write resource corresponds to the reallocated spare write resource.

13. The method of claim 1, wherein a first namespace comprises the first logical zone and a second namespace comprises the second logical zone, and
wherein the reallocating comprises performing, by the zone manager, a global overdrive operation of reclaiming a spare write resource of the first namespace and reallocating the spare write resource to the second namespace.

14. The method of claim 1, wherein a first namespace comprises the first logical zone and a second namespace comprises the second logical zone,
wherein the method further comprises:
determining, by the zone manager, that the first namespace is in an inactive state; and
reclaiming, by the zone manager, the first spare write resource and the second spare write resource from the first namespace and adding the first spare write resource and the second spare write resource to a global pool, and
wherein the reallocating comprises performing, by the zone manager, a first global overdrive operation of reallocating the first spare write resource and the second spare write resource to the second namespace.

15. The method of claim 14, further comprising:
performing, by the zone manager, a stripe group open operation for a third stripe group of the second logical zone by allocating a first physical zone, a second physical zone, a third physical zone, and a fourth physical zone to the third stripe group, based on the third essential write resource, the fourth essential write resource, the third spare write resource, and the fourth spare write resource;
performing, by the zone manager, a stripe group close operation for the third stripe group;
performing, by the zone manager, a stripe group open operation for a fourth stripe group of the second logical zone by allocating a fifth physical zone, a sixth physical zone, a seventh physical zone, an eighth physical zone, a ninth physical zone, and a tenth physical zone to the fourth stripe group, based on the third essential write resource, the fourth essential write resource, the third spare write resource, and the fourth spare write resource, the first spare write resource, and the second spare write resource; and
performing, by the zone manager, a stripe group close operation for the fourth stripe group.

16. The method of claim 15, wherein the performing the stripe group close operation for the fourth stripe group comprises:
determining whether a reallocated spare write resource exists in the fourth stripe group; and
reclaiming the first spare write resource and the second spare write resource from the fourth stripe group based on a determination that the reallocated spare write resource exists in the fourth stripe group, wherein each of the first spare write resource and the second spare write resource corresponds to the reallocated spare write resource.

17. The method of claim 1, wherein a first namespace comprises the first logical zone and a second namespace comprises the second logical zone,
wherein the method further comprises:
determining, by the zone manager, that the first namespace is in a suspended state based on there being no write request for the first namespace a predetermined period of time;
performing, by the zone manager, a compaction operation on the first namespace; and
reclaiming, by the zone manager, the first spare write resource and the second spare write resource from the first namespace and adding the first spare write resource and the second spare write resource to a global spare pool, and
wherein the reallocating comprises performing, by the zone manager, an overdrive operation of reallocating the first spare write resource and the second spare write resource to the second namespace.

18. The method of claim 17, further comprising:
performing a stripe group open operation for a first stripe group of the first logical zone by allocating a first physical zone, a second physical zone, a third physical zone, and a fourth physical zone to the first stripe group, based on the first essential write resource, the second essential write resource, the first spare write resource, and the second spare write resource; and
performing a write operation on the first stripe group.

19-21. (canceled)

22. A storage system comprising:
a host device comprising a zone manager; and
a storage device configured to manage a storage space in units of zones,
wherein the zone manager is configured to allocate a first essential write resource and a first spare write resource to a first logical zone,
wherein the zone manager is configured to allocate a second essential write resource and a second spare write resource to a second logical zone,
wherein the zone manager is configured to reclaim the first spare write resource from the first logical zone based on a write resource utilization rate and reallocate the first spare write resource to the second logical zone,
wherein the zone manager is configured to measure a read latency for each of the first logical zone and the second logical zone and, based on the read latency exceeding a threshold, perform a congestion control operation on a logical zone corresponding to the read latency exceeding the threshold, and
wherein the zone manager is configured to monitor an average write latency and periodically generate write tokens in each of the first logical zone and the second logical zone at each time corresponding to the average write latency.

23. A method of operating a storage system comprising a host device and a storage device, the host device comprising a zone manager, the method comprising:
allocating, by the zone manager, a first physical zone and a second physical zone to a first stripe group of a first logical zone based on a first essential write resource and a first spare write resource;
allocating, by the zone manager, a third physical zone and a fourth physical zone to a second stripe group of a second logical zone based on a second essential write resource and a second spare write resource;
allocating, by the zone manager, a fifth physical zone to a third stripe group of the first logical zone based on the first essential write resource; and
allocating, by the zone manager, a sixth physical zone, a seventh physical zone, and an eighth physical zone to a fourth stripe group of the second logical zone based on the second essential write resource, the second spare write resource, and the first spare write resource, which is reallocated from the first logical zone.
